(19) United States
(12) Patent Application Publication
(10) Pub. No.: US 2004/0239246 A1
(43) Pub. Date: Dec. 2, 2004

(54) Plasma display panel, plasma display displaying device and production method of plasma display panel

(76) Inventors: Hideki Asida, Settsu-shi (JP); Hiroyuki Yonehara, Hirakata-shi (JP); Keisuke Sumida, Hirakata-shi (JP); Morio Fujitani, Takatsuki-shi (JP); Junichi Hibino, Kyoto-shi (JP); Shinya Fujiwara, Kyoto-shi (JP); Hideki Marunaka, Kyoto-shi (JP); Tadashi Nakagawa, Takatsuki-shi (JP)

Correspondence Address: SNELL & WILMER LLP, 1920 MAIN STREET, SUITE 1200, IRVINE, CA, 92614-7230, US

(21) Appl. No.: 10/480,366

(22) PCT Filed: Jun. 11, 2002
(86) PCT No.: PCT/JP02/05770

(30) Foreign Application Priority Data
Jun. 12, 2001 (JP) 2001-176585

(51) Int. Cl. H01J 17/49; H01J 9/00; H01J 9/24

(52) U.S. Cl. 313/582; 445/24; 313/584

(57) ABSTRACT

A plasma display panel includes a substrate on which a plurality of electrodes formed by sintering a conductive material are arranged. Each electrode has a first part that is positioned within a display area on the substrate, and a second part that is positioned outside the display area on the substrate and has a smaller film thickness than the first part.

### TECHNICAL FIELD

The present invention relates to a manufacturing method for a plasma display panel for use in a display device and the like, and in particular relates to a manufacturing method for electrodes.

### BACKGROUND ART

In recent years, among display devices for use in computers, televisions, etc., plasma display panels (hereafter simply, “PDPs”) have attracted attentions as display devices that can have large screens but can be slim and lightweight.

FIG. 1 schematically shows a typical AC (alternating current) PDP 100.

The PDP 100 is roughly composed of a front plate 90 and a back plate 91 placed so that their respective main surfaces are opposed to each other.

The front plate 90 is composed of a front glass substrate 101, display electrodes 102, a dielectric layer 106, and a protective layer 107.

The front glass substrate 101 is a base material for the front plate 90. The display electrodes 102 are formed on the front glass substrate 101.

The display electrodes 102 are each made up of a transparent electrode 103, a black electrode film 104, and a bus electrode 105.

The black electrode film 104 is mainly composed of ruthenium oxide, which shows black. With its main component showing black, the black electrode film 104 prevents reflection of light coming from outside as viewed from the front surface of the front glass substrate 101.

The bus electrode 105 is mainly composed of silver, which has a high conductivity. With its main component being highly conductive, the bus electrode 105 lowers a resistance of the entire display electrode.

For ease of explanation, a combination of the black electrode film 104 and the bus electrode 105 is referred to as a multilayer electrode 309.

The multilayer electrode 309 has, at its one end in the longitudinal direction, a rectangular terminal part 108 where the electrode's width is locally expanded. The rectangular terminal part 108 serves as an interface for connection to a driving circuit.

The display electrodes 102 and the front glass substrate 101 are further covered by the dielectric layer 106 and then by the protective layer 107.

The back plate 91 is composed of a back glass substrate 111, address electrodes 112, a dielectric layer 113, barrier ribs 114, and phosphor layers 115. The phosphor layers 115 are each formed on the wall surface of a groove formed between adjacent barrier ribs 114 (hereafter, a “barrier rib groove”)

As shown in FIG. 1, the front plate 90 and the back plate 91 are placed one on top of another and are sealed, so that a discharge space 116 is formed between the front plate 90 and the back plate 91.

It should be noted here that although the figure illustrates the side edge of the back plate 91 in the Y-axis direction as being open for ease of explaining the structure of the back plate 91, all the side edges of the back plate 91 are actually bonded and sealed via sealing glass.

In the discharge space 116, a discharge gas (inner gas) composed of rare gas elements, such as He, Xe, and Ne, is enclosed at a pressure of about 500 to 600 torr (66.5 to 79.8 kPa).

An area where a pair of adjacent display electrodes 102 cross one address electrode 112 over the discharge space 116 corresponds to a cell that contributes to image display.

The PDP 100 and the driving circuit are connected, to form a PDP device 140.

The driving circuit has a circuit for applying voltage to the address electrodes 112 and the display electrodes 102 based on an image signal transmitted from a memory or from an external source.

Here, two display electrodes 102 extend through one cell as described above, and one of them is referred to as an X electrode and the other is referred to as a Y electrode. X electrodes and Y electrodes are alternately arranged.

In this PDP device 140, address discharge is caused by applying voltage between an X electrode and an address electrode 112 extending through a target cell to be lit, and then sustain discharge is caused by applying pulse voltage to the X electrode and a Y electrode extending through the target cell.

In this PDP device 140, the sustain discharge causes ultraviolet rays to be generated in the discharge space 116. The ultraviolet rays excite the phosphor layer 115 so that the ultraviolet rays are converted into visible light, thereby lighting the target cell. In this way, an image is displayed.

The following describes a method for forming the multilayer electrode 309, i.e., the black electrode film 104 and the bus electrode 105.

FIGS. 2A to 2E show one example of a manufacturing method for a conventional multilayer electrode.

As shown in FIG. 2A, a photosensitive material containing for example ruthenium oxide etc. is applied on a front glass substrate 302 by printing or the like, to form a black electrode film precursor 301.

As shown in FIG. 2B, a photosensitive material containing for example Ag etc. is applied on the black electrode film precursor 301 by printing or the like, to form a bus electrode precursor 303.

As shown in FIG. 2C, the front glass substrate 302 on which the black electrode film precursor 301 and the bus electrode precursor 303 are formed is exposed to ultraviolet rays 304 through an exposure mask 305, so that exposed parts 307 and unexposed parts 306 are formed in the black electrode film precursor 301 and the bus electrode precursor 303.

During the exposure to ultraviolet rays, photosensitive elements in the photosensitive materials are hardened gradually from the film surface.

As shown in FIG. 2D, the front glass substrate 302 on which the black electrode film precursor 301 and the bus electrode precursor 303 are formed is developed using a developer containing alkali etc., so that only the exposed parts 307 of the black electrode film precursor 301 and the bus electrode precursor 303 remain on the substrate. This results in a multilayer electrode precursor 308 that is a laminate of the patterned black electrode film precursor 301 and the patterned bus electrode precursor 303.

In this way, the multilayer electrode precursor 308 has a double-layer structure composed of the black electrode film precursor 301 and the bus electrode precursor 303.

As shown in FIG. 2E, the multilayer electrode precursor 308 is baked, so that molecules in the material of the multilayer electrode precursor 308 remaining on the substrate after the developing are sintered, to shorten distances among the molecules.

Due to the baking, the multilayer electrode precursor 308 reduces its volume.

The black electrode film precursor 301 of the multilayer electrode precursor 308 after the sintering corresponds to the black electrode film 104, and the bus electrode precursor 303 of the multilayer electrode precursor 308 after the sintering corresponds to the bus electrode 105.

It should be noted here that a method for laminating another layer on the bus electrode 105 using the same material as the material used for the bus electrode 105 may be employed, to further lower a resistance of the entire electrode.

Here, this baking process has the following problem.

When the multilayer electrode 309 is formed by baking the multilayer electrode precursor 308, there may be cases where edges of the multilayer electrode 309 in the longitudinal direction are peeled off.

Here, the edges of the multilayer electrode 309 intend to refer not only to an edge of the terminal part 108 of the multilayer electrode 309 but also to an edge of the other end part of the multilayer electrode 309 opposite to the terminal part 108.

This phenomenon of the edges of the multilayer electrode being peeled-off is hereafter referred to as the “electrode peeling-off phenomenon”.

FIG. 3 is a schematic view showing the electrode peeling-off phenomenon.

The figure specifically focuses on two adjacent multilayer electrodes 309, i.e., an X electrode and a Y electrode. For ease of explanation, the multilayer electrode positioned front in the figure is given reference numeral 309a and the other multilayer electrode is given reference numeral 309b.

Here, a transparent electrode 103a, a black electrode film 104a, a bus electrode 105a, and a terminal part 108a of the multilayer electrode 309a respectively correspond to the transparent electrode 103, the black electrode film 104, the bus electrode 105, and the terminal part 108 described above.

A transparent electrode 103b, a black electrode film 104b, a bus electrode 105b, and a terminal part 108b of the multilayer electrode 309b respectively correspond to the transparent electrode 103, the black electrode film 104, the bus electrode 105, and the terminal part 108 described above.

The multilayer electrodes 309a and 309b in the normal state where the electrode peeling-off phenomenon does not occur are shown at the lower left in FIG. 3. In this normal state, the terminal part 108a of the multilayer electrode 309a, i.e., the end part of the multilayer electrode 309a in the X-axis right direction, is entirely adhered to the front glass substrate 101.

Also, in the normal state, the end part of the multilayer electrode 309b in the X-axis right direction is entirely adhered to the front glass substrate 101.

The multilayer electrode 309a and the multilayer electrode 309b formed in the normal state do not pose any quality problems. However, there are cases where the multilayer electrode 309a and the multilayer electrode 309b are in a peeled-off state where the electrode peeling-off phenomenon occurs as shown in the lower right in FIG. 3.

Such an electrode peeling-off phenomenon occurs not only at the edge of the terminal part of the multilayer electrode but also at the edge of the other end part of the multilayer electrode opposite to the terminal part.

In the baking process, the multilayer electrode 309 composed of laminated metallic films containing photosensitive materials reduces its volume, because the photosensitive materials and the like contained therein vaporize into an atmosphere and the remaining materials and the like are sintered, to shorten the distances among molecules therein.

The electrode peeling-off phenomenon is considered to be caused by stresses generated in the multilayer electrode 309. Such stresses are generated in the multilayer electrode 309 when the multilayer electrode 309 fixed to the front glass substrate 101 at the contact surface is shrunk in the above-described way.

If the electrode peeling-off phenomenon occurs in end parts of multilayer electrodes in the baking process for forming the multilayer electrodes, the completed PDP suffers from quality defects.

### DISCLOSURE OF THE INVENTION

In view of the above problems, the present invention aims to provide a PDP whose baking process has a low probability of causing the electrode peeling-off phenomenon, a PDP device that includes the PDP, and a manufacturing method for the PDP whose baking process has a low probability of causing the electrode peeling-off phenomenon.

To achieve the above aim, the PDP of the present invention includes a substrate on which a plurality of electrodes are arranged, the electrodes being formed by sintering a conductive material, and is characterized in that each electrode includes (a) a first part that is positioned within a display area on the substrate, and (b) a second part that is positioned outside the display area on the substrate and that has a smaller film thickness than the first part.

When each electrode has internal stresses generated in the longitudinal direction depending on its film thickness, such internal stresses generated in the second part are smaller than such internal stresses generated in the first part according to the above construction.

To be specific, shearing stresses in the second part that are generated after baking of the electrode and that may cause the electrode peeling-off phenomenon can be reduced. Therefore, the electrode peeling-off phenomenon occurring in the second part can be prevented.

Here, the display area may be an area where cells corresponding to a discharge space are arranged.

According to this construction, each electrode has a smaller film thickness in the second part than in a part included in the area where the cells are arranged.

Here, although a resistance of the electrode in its second part tends to be higher than a resistance of the electrode in its part in the vicinity of cells, an increase in a resistance of the entire electrode is at a tolerable level because the area where the cells are arranged occupies a large part of the electrode.

Moreover, the part of the electrode included in the area where the cells are provided needs to have a narrow width, due to the necessity of providing improved illuminance. Therefore, decreasing the film thickness of the part of the electrode included in the area where the cells are arranged directly increases the resistance of the electrode. On the other hand, decreasing the film thickness of the part of the electrode in the area where cells are not arranged, i.e., the second part of the electrode, is less likely to directly increase the resistance of the electrode. Therefore, a disadvantage caused by decreasing the film thickness of the second part of the electrode is small.

Also, the film thickness of the second part may be 5 μm or less.

When each electrode has internal stresses generated in the longitudinal direction depending on its film thickness, such internal stresses generated in the second part can be equal to or smaller than internal stresses generated therein when the film thickness is 5 μm or less.

To be more specific, if the second part includes a range where the electrode peeling-off phenomenon may occur, when the film thickness of the electrode is 5 μm or less, stresses large enough to cause the electrode peeling-off phenomenon are less likely to be generated in the baking process for forming the electrodes. Therefore, the electrode peeling-off phenomenon can be prevented.

Also, the second part may occupy an area of the electrode from an end face of the electrode to a position that is at least 10 μm from the end face in a longitudinal direction.

According to this construction, an area where the internal stresses are reduced and the resistance increases due to a reduced film thickness can be limited to the above area from the end face of the electrode to the position that is 10 μm from the end face.

To be specific, the area where the resistance increases is so narrow that such an increase in the resistance is at a tolerable level, while the electrode peeling-off phenomenon is being prevented.

Also, the first part may include at least a first electrode film and a second electrode film, and an end of the first electrode film and an end of the second electrode film may be at different positions, whereby the second part has a smaller thickness than the first part.

According to this construction, the end part has a smaller number of layers laminated therein than the first part and therefore can have a smaller film thickness than the first part.

Also, the first electrode film may be formed on the substrate, and the second electrode film is formed on the first electrode film, and the end of the first electrode film may be at a position that is away by a predetermined distance from the end of the second electrode film in such a manner that the end of the first electrode film extends from the end of the second electrode film.

According to this construction, a length of the first electrode film in the longitudinal direction can be longer than a length of the second electrode film in the longitudinal direction.

Also, the first electrode film may be formed on the substrate, and the second electrode film is formed on the first electrode film, and the end of the second electrode film may be at a position that is away by a predetermined distance from the end of the first electrode film in such a manner that the end of the second electrode film extends from the end of the first electrode film.

According to this construction, a length of the second electrode film in the longitudinal direction can be longer than a length of the first electrode film in the longitudinal direction.

Also, the second electrode film may contain at least one member selected from the group consisting of Ag, Cu, and Al.

According to this construction, conductivity of the electrode can be improved.

Also, the first electrode film may contain at least one member selected from the group consisting of Ag, Cu, Al, a black pigment, ruthenium oxide, and a complex compound of ruthenium, and the first electrode film may show one of black and gray.

According to this construction, when viewed from the side of the substrate opposite to the side where the electrodes are arranged, the electrodes can be perceived as black or gray.

Also, to achieve the above aim, the PDP of the present invention includes a substrate on which a plurality of electrodes are arranged, the electrodes being formed by sintering a conductive material, and is characterized in that each electrode has an end part with a larger width than other parts of the electrode, and at least one recession or through-hole is formed in the end part.

According to this construction, in the end part with a larger width, an edge-side part positioned at the edge side in the longitudinal direction of the electrode as viewed from the recession or through-hole is less likely to be influenced by stresses generated in an opposite-side part positioned at the opposite side to the edge-side part as viewed from the recession or through-hole.

To be more specific, when each electrode has internal stresses generated depending on its length in the longitudinal direction, such internal stresses generated in the edge-side part can be smaller than internal stresses generated in the opposite-side part because a length of the edge-side part in the longitudinal direction is shorter than that of other parts. Accordingly, shearing stresses in the edge-side part that are generated after baking of the electrode and that may cause the electrode peeling-off phenomenon can be reduced. Therefore, the electrode peeling-off phenomenon occurring in the second part can be prevented.

Also, the at least one recession or through-hole may be positioned on an extension of a longitudinal direction of a main part of the electrode other than the end part.

According to this construction, in the end part with a larger width, an edge-side part positioned at the edge side in the longitudinal direction of the electrode as viewed from the recession or through-hole is less likely to be influenced by stresses generated in an opposite-side part positioned at the opposite side to the edge-side part as viewed from the recession or through-hole.

Also, a PDP device of the present invention includes: the PDP that includes a substrate on which a plurality of electrodes are arranged, the electrodes being formed by sintering a conductive material, characterized in that each electrode includes (a) a first part that is positioned within a display area on the substrate, and (b) a second part that is positioned outside the display area on the substrate and that has a smaller film thickness than the first part, or the PDP characterized in that the at least one recession or through-hole is positioned on an extension of a longitudinal direction of a main part of the electrode other than the end part, and includes a driving circuit.

When each electrode has internal stresses generated in the longitudinal direction depending on its film thickness, such internal stresses generated in the second part are smaller than such internal stresses generated in the first part according to the above construction.

To be specific, shearing stresses in the second part that are generated after baking of the electrode and that may cause the electrode peeling-off phenomenon can be reduced. Therefore, the electrode peeling-off phenomenon occurring in the second part can be prevented. Due to this, a PDP device can exhibit improved quality.

Also, to achieve the above aim, a manufacturing method of the present invention for a PDP that includes a substrate, is characterized by including: an applying step of applying, on the substrate, a conductive material in a plurality of lines each extending over both a display area and an area outside the display area; and a baking step of baking the conductive material, to form electrodes, wherein each electrode formed by baking includes (a) a first part that is positioned within the display area on the substrate, and (b) a second part that is positioned within the area outside the display area on the substrate and that has a smaller film thickness than the first part.

When internal stresses are generated, in the baking step, in each electrode in the longitudinal direction depending on its film thickness, such internal stresses generated in the second part are smaller than such internal stresses generated in the first part according to the above method.

To be specific, shearing stresses in the second part that are generated after baking of the electrode and that may cause the electrode peeling-off phenomenon can be reduced. Therefore, the electrode peeling-off phenomenon occurring in the second part can be prevented.

Also, the display area may be an area where cells corresponding to a discharge space are arranged.

According to this method, each electrode has a smaller film thickness in the second part than in a part included in the area where the cells are arranged.

Here, although a resistance of the electrode in its second part tends to be higher than a resistance of the electrode in its part in the vicinity of cells, an increase in a resistance of the entire electrode is at a tolerable level because the area where the cells are arranged occupies a large part of the electrode.

Moreover, the part of the electrode included in the area where the cells are arranged needs to have a narrow width, due to the necessity of providing improved illuminance. Therefore, decreasing the film thickness of the part of the electrode included in the area where the cells are arranged directly increases the resistance of the electrode. On the other hand, decreasing the film thickness of the part of the electrode in the area where cells are not arranged, i.e., the second part of the electrode, is less likely to directly increase the resistance of the electrode. Therefore, a disadvantage caused by decreasing the film thickness of the second part of the electrode is small.

Also, the film thickness of the second part may be 5 μm or less.

When internal stresses are generated in each electrode in the longitudinal direction depending on its film thickness, such internal stresses generated in the second part can be equal to or smaller than internal stresses generated therein when the film thickness is 5 μm or less.

To be more specific, if the second part includes a range where the electrode peeling-off phenomenon may occur, when the film thickness of the electrode is 5 μm or less, stresses large enough to cause the electrode peeling-off phenomenon are less likely to be generated in the baking step for forming the electrodes. Therefore, the electrode peeling-off phenomenon can be prevented.

Also, in the applying step, the conductive material may be applied in such a manner that the second part of the electrode formed by baking occupies an area of the electrode from an end face of the electrode to a position that is at least 10 μm from the end face in a longitudinal direction.

According to this method, an area where the internal stresses are reduced and the resistance increases due to a reduced film thickness can be limited to the above area from the end face of the electrode to the position that is 10 μm from the end face.

To be specific, the area where the resistance increases is so narrow that such an increase in the resistance is at a tolerable level, while the electrode peeling-off phenomenon is being prevented.

Also, in the applying step, the conductive material may be applied as at least two layers that are a first layer and a second layer in a first area where the first part of the electrode is to be formed, and the conductive material may be applied as one of the first layer and the second layer in a second area where the second part of the electrode is to be formed.

According to this method, the end part has a smaller number of layers laminated therein than the first part and therefore can have a smaller film thickness than the first part.

Also, in the applying step, the conductive material may be applied by printing, and the conductive material may be applied by printing one of the first layer and the second layer in the second area.

According to this method, the second part of the electrode can be easily formed to have a reduced thickness.

Also, in the applying step, the conductive material may be applied as at least two layers that are a first layer and a second layer, and the conductive material may be applied by printing the first layer and the second layer in such a manner that a smaller amount of the conductive material is applied as the first layer or the second layer in a second area where the second part of the electrode is to be formed, than in a first area where the first part of the electrode is to be formed.

According to this method, the second part of the electrode can be easily formed to have a reduced thickness.

Also, a first mesh may be used in applying the conductive material in the first area, and a second mesh with a smaller opening ratio than the first mesh may be used in applying the conductive material in the second area, so that a smaller amount of the conductive material is applied in the second area than in the first area.

According to this method, an amount of the conductive material applied in the second area can be easily reduced.

Also, a first mesh may be used in applying the conductive material in the first area, and a mesh that is obtained by subjecting the first mesh to calendering may be used in applying the conductive material in the second area, so that a smaller amount of the conductive material is applied in the second area than in the first area.

According to this method, an amount of the conductive material applied in the second area can be easily reduced.

Also, the conductive material may be a mixture with a photosensitive material, in the applying step, the mixture may be applied as at least two layers on the substrate (b) by printing the mixture or (b) by applying laminated sheets of the mixture, and in a second area where the second part of the electrode is to be formed, exposure may be carried out using an exposure mask with such a tone width that does not exceed exposure resolution and then developing is carried out, to form the two layers.

According to this method, the second part of the electrode can be easily formed to have a reduced thickness.

Also, to achieve the above aim, a manufacturing method of the present invention for a PDP that includes a substrate, is characterized by including: an applying step of applying, on the substrate, a conductive material in a plurality of lines each extending over both a display area and an area outside the display area on the substrate, each line of the conductive material having an end part with a larger width than other parts of the line and having at least one recession or through-hole in the end part; and a baking step of baking the conductive material, to form electrodes.

According to this method, in the end part with a larger width, an edge-side part positioned at the edge side in the longitudinal direction of the electrode as viewed from the recession or through-hole is less likely to be influenced by stresses generated in an opposite-side part positioned at the opposite side to the edge-side part as viewed from the recession or through-hole.

To be more specific, when each electrode has internal stresses generated depending on its length in the longitudinal direction, such internal stresses generated in the edge-side part can be smaller than internal stresses generated in the opposite-side part because a length of the edge-side part in the longitudinal direction is shorter than that of other parts.

Accordingly, shearing stresses in the edge-side part that are generated after baking of the electrode and that may cause the electrode peeling-off phenomenon can be reduced. Therefore, the electrode peeling-off phenomenon occurring in the second part can be prevented.

Also, the at least one recession or through-hole may be positioned on an extension of a longitudinal direction of a main part of the line other than the end part.

According to this method, in the end part with a larger width, an edge-side part positioned at the edge side in the longitudinal direction of the electrode as viewed from the recession or through-hole is further less likely to be influenced by stresses generated in an opposite-side part positioned at the opposite side to the edge-side part as viewed from the recession or through-hole.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a schematic view of one example of a typical AC PDP;

FIGS. 2A to 2E show one example of a manufacturing method for a conventional multilayer electrode;

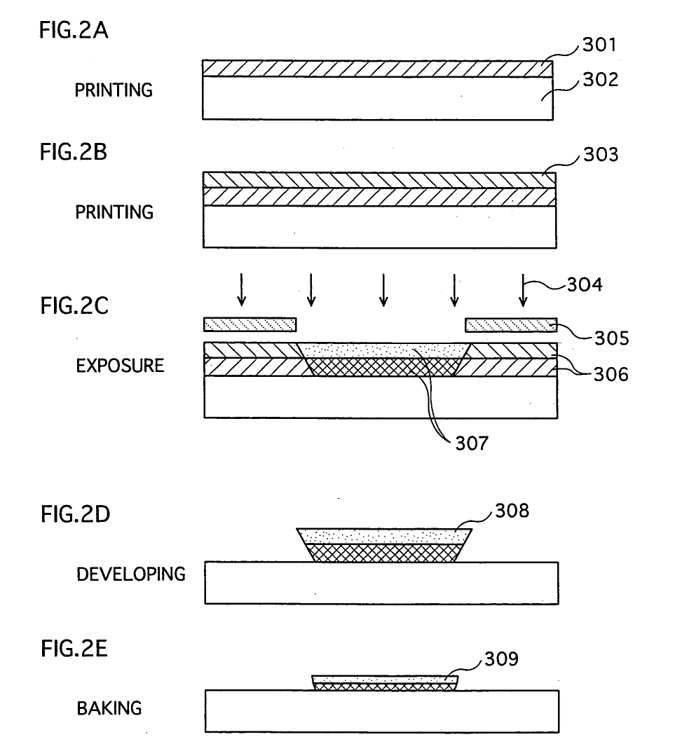

FIG. 3 is a schematic view showing the electrode peeling-off phenomenon;

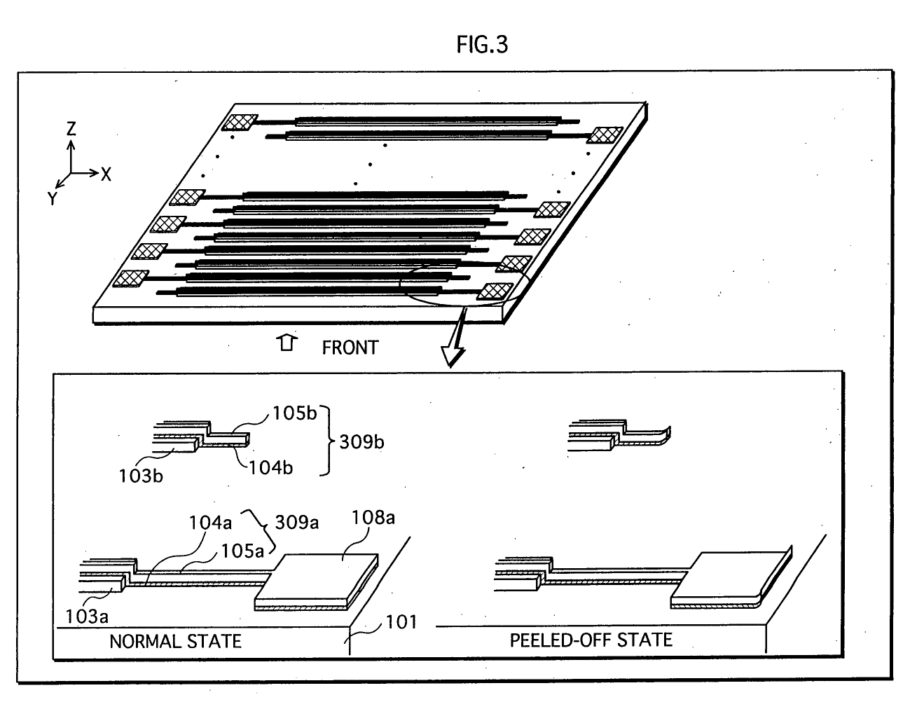

FIG. 4 is a schematic view of a PDP relating to a first embodiment of the present invention;

FIG. 5 is a schematic view showing the shape of end parts of multilayer electrodes;

FIG. 6 shows the construction of a PDP device;

FIGS. 7A to 7F are diagrams for explaining a method for forming a multilayer electrode;

FIG. 8 shows the relationship between (a) the thickness of a multilayer electrode after developing and (b) the frequency of the electrode peeling-off phenomenon;

FIG. 9 schematically shows stresses generated at the contact surface between a conventional multilayer electrode and a front glass substrate;

FIG. 10 is a diagram for explaining internal stresses generated in an end part of a multilayer electrode after baking in the first embodiment;

FIGS. 11A to 11G are diagrams for explaining a method for forming a multilayer electrode of a PDP relating to a second embodiment of the present invention;

FIGS. 12A to 12F are diagrams for explaining a method for forming a multilayer electrode of a PDP relating to a third embodiment of the present invention;

FIG. 13 shows the relationship between (a) a pattern of a halftone exposure mask and (b) a film thickness after developing, when a photosensitive material is subjected to halftone exposure;

FIGS. 14A to 14F are diagrams for explaining a method for forming a multilayer electrode of a PDP relating to a fourth embodiment of the present invention;

FIGS. 15A to 15G are diagrams for explaining a method for forming a multilayer electrode of a PDP relating to a fifth embodiment of the present invention; and

FIGS. 16A and 16B are diagrams for explaining a shape of a multilayer electrode of a PDP relating to a sixth embodiment of the present invention.

### BEST MODE FOR CARRYING OUT THE INVENTION

[First Embodiment]

<Construction>

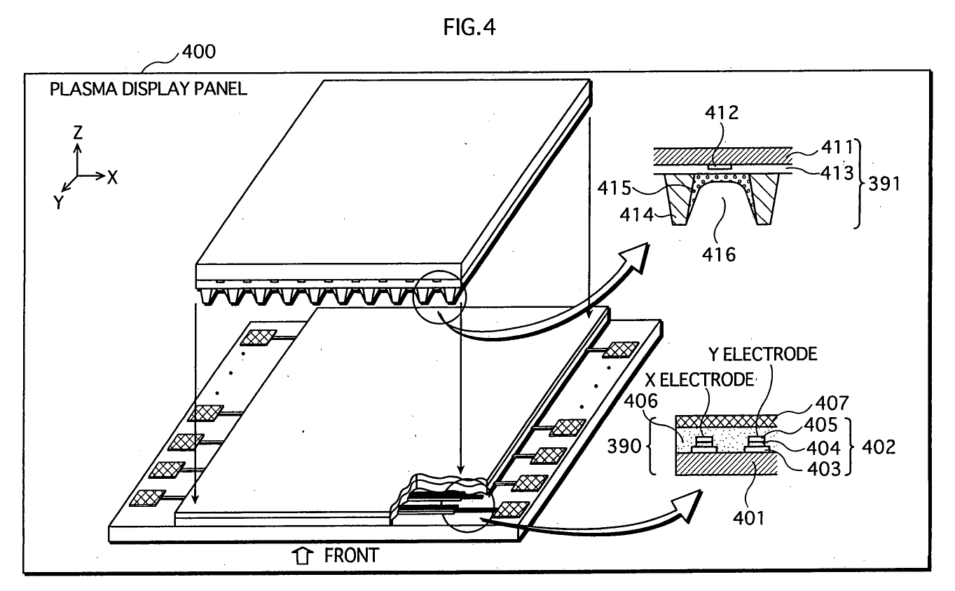

FIG. 4 is a schematic view of a PDP 400 relating to a first embodiment of the present invention.

The PDP 400 is roughly composed of a front plate 390 and a back plate 391 placed so that their respective main surfaces are opposed to each other.

In the figure, the Z direction corresponds to a thickness direction of the PDP, and the X-Y plane corresponds to a plane parallel to the PDP surface.

The front plate 390 is composed of a front glass substrate 401, display electrodes 402, a dielectric layer 406, and a protective layer 407.

The front glass substrate 401 is a base material for the front plate 390. The display electrodes 402 are formed on the front glass substrate 401.

The display electrodes 402 are each made up of a transparent electrode 403, a black electrode film 404, and a bus electrode 405.

The transparent electrodes 403 are formed by applying a conductive metallic oxide, such as ITO, SnO₂, and ZnO, in a plurality of lines on one surface of the front glass substrate 401 with the longitudinal direction of the lines being the X direction.

Focusing now on each cell, two display electrodes 402 extend through one cell, and one of them is referred to as an X electrode and the other is referred to as a Y electrode. X electrodes and Y electrodes are alternately arranged.

The black electrode film 404 is formed by applying, in a layer, a material mainly composed of ruthenium oxide on the transparent electrode 403, so that the layer formed is narrower than the transparent electrode 403.

The bus electrode 405 is formed by applying, in a layer, a conductive material containing Ag on the black electrode film 404.

The PDP 400 relating to the first embodiment of the present invention differs from the conventional PDP 100 in the following point. In the PDP 400 relating to the first embodiment, the black electrode film 404 and the bus electrode 405 are not formed so as to fit in completely the same ranges but the formation ranges of the black electrode film 404 and the bus electrode 405 differ at their ends in the longitudinal direction.

For ease of explanation, a combination of the black electrode film 404 and the bus electrode 405 is referred to as a multilayer electrode 409.

The following describes the multilayer electrode 409 in detail.

The multilayer electrode 409 has, at its one end in the longitudinal direction, a rectangular terminal part 408 where the electrode's width is locally expanded. The rectangular terminal part 408 serves as an interface for connection to a driving circuit 419 that is described later.

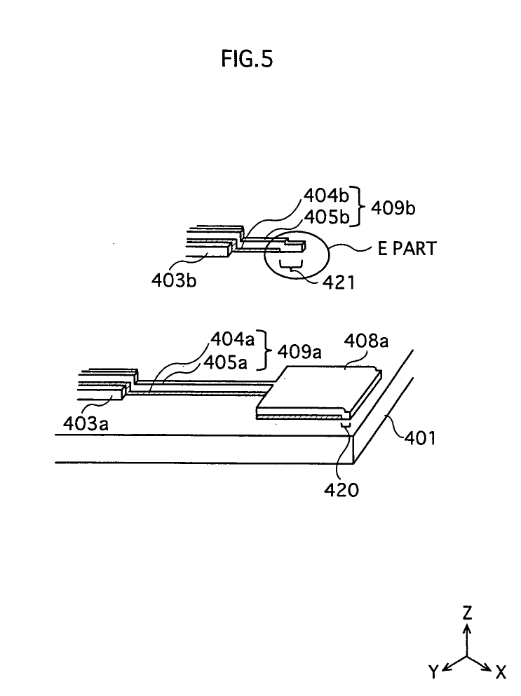

FIG. 5 is a schematic view showing the shape of end parts of multilayer electrodes 409.

The figure specifically focuses on two adjacent multilayer electrodes 409. For ease of explanation, the multilayer electrode positioned front in the figure is given reference numeral 409a and the other multilayer electrode is given reference numeral 409b.

The multilayer electrode 409a is composed of a black electrode film 404a and a bus electrode 405a, and has a terminal part 408a serving as an interface for connection to the driving circuit 419.

The transparent electrode 403a together with the multilayer electrode 409a forms a path for feeding power to each cell.

The multilayer electrode 409b and the multilayer electrode 409a have the same constructions, and are arranged in directions reverse to each other.

The end part of the multilayer electrode 409b shown in FIG. 5 corresponds to the end part of the multilayer electrode 409a opposite to the end part of the multilayer electrode 409a shown in FIG. 5.

The multilayer electrode 409b is composed of a black electrode film 404b and a bus electrode 405b, and has a terminal part 408b (not shown) serving as an interface for connection to the driving circuit 419.

The transparent electrode 403b together with the multilayer electrode 409b forms a path for feeding power to each cell.

At the edge of the terminal part 408a, i.e., at the edge of the end part of the multilayer electrode 409 in the longitudinal direction, an end of the bus electrode 405a is positioned away from an end of the black electrode film 404a in such a manner that the end of the bus electrode 405a extends from the end of the black electrode film 404a. Due to this, the multilayer electrode 409a has, at the edge, a thin part 420 with a thickness of 5 μm or less formed only by the black electrode film 404a.

In the same manner, at the edge of the other end part of the multilayer electrode 409b in the longitudinal direction (at the edge of the end part where the terminal part 408b is not provided), an end of the bus electrode 405b is positioned away from an end of the black electrode film 404b in such a manner that the end of the bus electrode 405b extends from the end of the black electrode film 404b. Due to this, the multilayer electrode 409b has, at the edge, a thin part 421 with a thickness of 5 μm of less formed only by the black electrode film 404b.

Every multilayer electrode has such thin parts at its both ends.

The dielectric layer 406 is made from a dielectric material and is formed to cover the entire surface of the front glass substrate 401 where the display electrodes 402 are formed. Lead glass with a low melting point is typically used as the material, but bismuth glass with a low melting point or a laminate of these two types of glass may also be used.

The protective layer 407 is a thin layer made of MgO and is formed to cover the entire surface of the dielectric layer 406.

The back plate 391 is composed of a back glass substrate 411, address electrodes 412, a dielectric layer 413, barrier ribs 414, and phosphor layers 415. The phosphor layers 415 are each formed on the wall surface of a barrier rib groove formed between adjacent barrier ribs 414.

The back glass substrate 411 is a base material for the back plate 391. The address electrodes 412 are formed on the back glass substrate 411′.

The address electrodes 412 are metal electrodes (e.g., silver electrodes, or Cr—Cu—Cr electrodes). The address electrodes 412 are formed by applying a conductive material containing Ag in a plurality of lines on one surface of the back glass substrate 411 with the longitudinal direction of the lines being the Y direction.

The address electrodes 412 each typically have a thickness of 5 μm or less.

The dielectric layer 413 is made from a dielectric material and is formed to cover the entire surface of the back glass substrate 411 where the address electrodes 412 are formed. Lead glass with a low melting point is typically used as the material, but bismuth glass with a low melting point or a laminate of these two types of glass may also be used.

On the dielectric layer 413, the barrier ribs 414 are formed with such a pitch determined in accordance with a pitch of adjacent address electrodes 412.

On the wall surface of each barrier rib groove formed between adjacent barrier ribs 414, the phosphor layer 415 corresponding to one of red, green, and blue is formed.

To be more specific, the phosphor layers 415 are of three types that respectively emit red light, green light, and blue light with a different wavelength when excited by emitted ultraviolet rays. These three types of phosphor layers 415 are alternately applied in the order of red, green, and blue on the wall surface of barrier rib grooves.

As shown in FIG. 4, the front plate 390 and the back plate 391 are placed one on top of another, and are sealed, so that a discharge space 416 is formed between the front plate 390 and the back plate 391.

In the discharge space 416, a discharge gas (inner gas) composed of rare gas elements, such as He, Xe, and Ne, is enclosed at a pressure of about 500 to 600 torr (66.5 to 79.8 kPa) An area where a pair of adjacent display electrodes 402 cross one address electrode 412 over the discharge space 416 corresponds to a cell that contributes to image display.

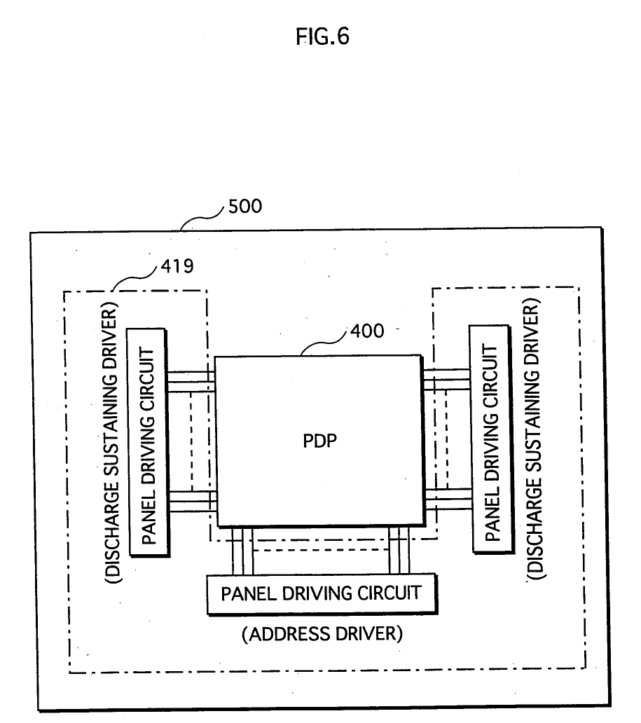

As shown in FIG. 6, the PDP 400 and the driving circuit 419 form a PDP device 500. In the PDP device 500, address discharge is caused by applying voltage between an X electrode and an address electrode 412 extending through a target cell to be lit, and then sustain discharge is caused by applying pulse voltage to a pair of display electrodes extending through the target cell.

The sustain discharge causes ultraviolet rays (with a wavelength of about 147 mm) to be generated. The ultraviolet rays excite the phosphor layer 415 so that the ultraviolet rays are converted into visible light, thereby lighting the target cell. In this way, an image is displayed.

<Manufacturing Method for the PDP>

The PDP 400 is formed by placing the front plate 390 and the back plate 391 one on top of another, sealing the front plate 390 and the back plate 391, and then enclosing a discharge gas in a space formed between the plates.

The following describes a manufacturing method for the front plate 390.

According to a manufacturing method for a gas discharge display panel of the present invention, the transparent electrodes 404 are formed by applying a conductive material, such as ITO and SnO₂, in a plurality of parallel lines with a thickness of about 1400 Å on the front glass substrate 401, using such a conventional technique as vapor deposition and sputtering. The front glass substrate 401 employed here is made of soda glass, and has a thickness of about 2.8 mm.

Using such a conventional technique as screen printing and photolithography, a precursor of the black electrode film 404 (here after referred to as a “black electrode film precursor 404z”) mainly composed of ruthenium oxide and a precursor of the bus electrode 405 (hereafter referred to as a “bus electrode precursor 405z”) made of Ag, i.e., in combination a precursor of the multilayer electrode 409 (hereafter referred to as a “multilayer electrode precursor 409z”), are formed on each transparent electrode 403 formed on the front glass substrate 401.

Here, the multilayer electrode precursor 409z relating to the first embodiment has, at its each end part, a thin part not formed by the black electrode film precursor 404z but formed only by the bus electrode precursor 405z.

The front glass substrate 401 on which these precursors and the like are formed in the above-described way is baked using an IR furnace whose temperature profile has a peak temperature in a range of 550 to 600° C. (preferably in a range of 580 to 600° C.), so that the multilayer electrode precursors 409z are sintered, to form the black electrode films 404 and the bus electrodes 405.

It should be noted here that the black electrode films 404 and the bus electrodes 405, together with the transparent electrodes 403, constitute the display electrodes 402.

<Method for Forming the Multilayer Electrodes>

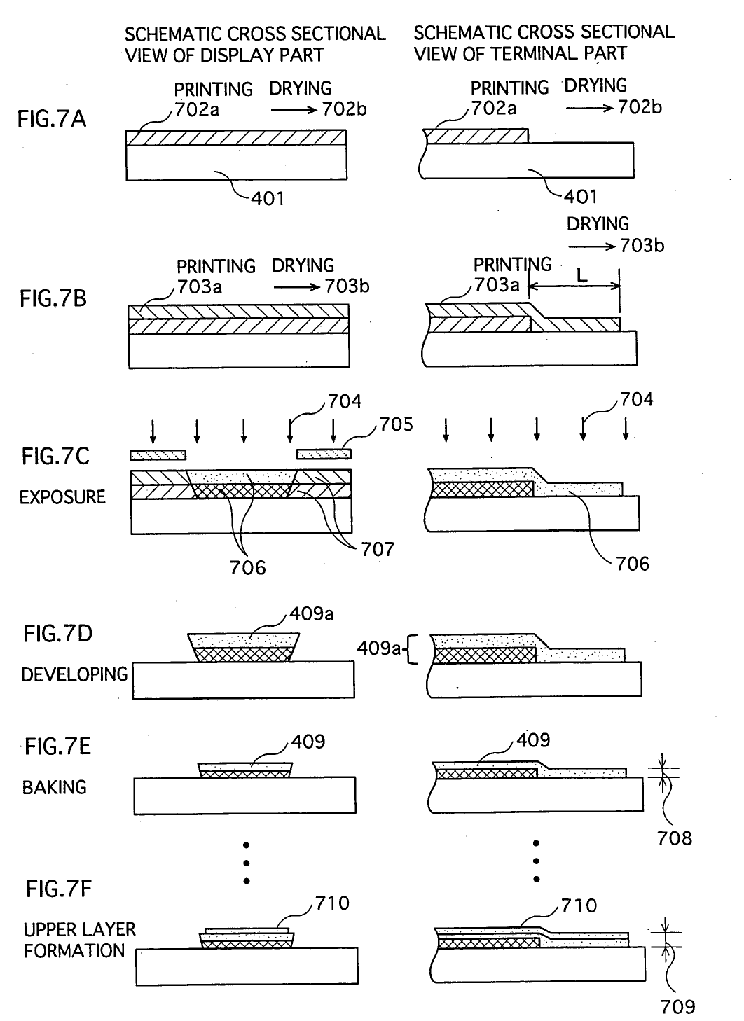

FIGS. 7A to 7F are diagrams for explaining a method for forming the above-described multilayer electrodes 409.

The following particularly describes, as one example, a method for forming the E part of the multilayer electrode 409 shown in FIG. 5, among a plurality of lines of multilayer electrodes 409 formed on the front glass substrate 401.

First, a black nega-type photosensitive paste 702a containing ruthenium oxide particles is applied on the front glass substrate 401, by screen printing. Then, the front glass substrate 401 on which the photosensitive paste 702a is applied is dried using an IR furnace whose temperature profile has a linear heating from a room temperature to a temperature in a range of 80 to 120° C. inclusive and then has a plateau of a fixed period of time at the reached temperature. Due to this drying, solvents and the like are removed from the nega-type photosensitive paste 702a, to form the black electrode film precursor 702b (FIG. 7A).

Here, a range corresponding to the thin part 421 is excluded from the range where the nega-type photosensitive paste 702a is printed.

Following this, a nega-type photosensitive paste 703b containing Ag particles is applied by screen printing on the black electrode film precursor 702b formed on the front glass substrate 401. The front glass substrate 401 on which the black electrode film precursor 702b is formed and the photosensitive paste 703a is applied is dried using an IR furnace whose temperature profile is the same as the temperature profile described above. Due to this drying, solvents and the like are reduced from the photosensitive paste 703a, to form the bus electrode precursor 703b (FIG. 7B).

Here, a range corresponding to the thin part 421 is included in the range where the photosensitive paste 703a is printed. The length “L” of the thin part 421 in the X-axis direction is 10 μm or more.

Following this, an exposure mask 705 is placed on the bus electrode precursor 703b. The front glass substrate 401 on which the black electrode film precursor 702b and the bus electrode precursor 703b are formed is exposed to ultraviolet rays 704 through the exposure mask 705. This causes a cross-linking reaction in the vicinity of the film surface of the bus electrode precursor 703b, and the cross-linking reaction proceeds toward the black electrode film precursor 702b provided below the bus electrode precursor 703b. Parts of the bus electrode precursor 703b and the black electrode film precursor 702b where the cross-linking reaction occurs are polymerized, resulting in exposed parts 706 and unexposed parts 707 being formed (FIG. 7C).

It should be noted here that the condition of exposure employed here is such that a illuminance is in a range of 5 to 20 mW/cm², an accumulated quality of light is in a range of 100 to 600 mJ/cm², and the distance between the mask and the substrate (hereafter, a “proxy amount”) is in a range of 50 to 250 μm.

Following this, the front glass substrate 401 on which the black electrode film precursor 702b and the bus electrode precursor 703b are formed is developed using a developer containing 0.3 to 0.5 wt % of sodium carbonate, so that the unexposed parts 707 are removed. As a result, the exposed parts 706, i.e., a precursor of the multilayer electrode 409b (hereafter referred to as a “multilayer electrode precursor 409d”) remain on the front glass substrate 401 (FIG. 7D).

Following this, the front glass substrate 401 on which the multilayer electrode precursor 409d is formed is baked using a continuous belt furnace with a peak temperature in a range of 550 to 600° C. (preferably in a range of 580 to 600° C.). Due to the baking, in the multilayer electrode precursor 409d remaining after the developing, the resin elements etc. burn out and vaporize, the glass frit melts, and the conductive material sinters, to form the multilayer electrode 409b (FIG. 7E).

Due to this sintering, the multilayer electrode precursor 409d reduces its apparent volume, wire width, and film thickness, to become the multilayer electrode 409b.

Here, the film thickness 708 of the thin part 421 is 5 μm or less.

Here, for example, to further lower a resistance of the multilayer electrode 409b, another layer of the same material as the photosensitive paste 703a may be laminated, by printing, on the multilayer electrode 409b formed on the front glass substrate 401. In this case, the newly generated multilayer electrode 710 (FIG. 7F) after going through the lamination processes shown in FIGS. 7B to 7E should be such that the film thickness 709 of the thin part 421 after baking is 5 μm or less.

Using such a conventional technique as printing, a precursor of the dielectric layer 406 (hereafter referred to as a “dielectric layer precursor 406a”) is formed on the surface of the front glass substrate 401 on which the black electrode film 404 and the bus electrode 405 are formed in the above-described way.

The dielectric layer precursor 406a is sintered, to form the dielectric layer 406.

On the dielectric layer 406, the protective layer 407 is formed using such a conventional technique as sputtering.

As described above, the PDP manufacturing method of the present invention differs from conventional methods in a process of forming the multilayer electrode precursor 409z to have, at its end part, a thin part not formed by the black electrode film precursor 404z but formed only by the bus electrode precursor 405z, and the multilayer electrode 409 formed by baking the multilayer electrode precursor 409z has, at its end part, the thin part with a film thickness of 5 μm or less.

The following describes a manufacturing method for the back plate 391.

The back plate 391 relating to the first embodiment is manufactured with the same method as conventional manufacturing methods. To be specific, precursors of the address electrodes 412 (hereafter referred to as “address electrode precursors 412a”) with a film thickness of 1 to 5 μm are formed on the back glass substrate 411 by applying, by way of screen printing, a conductive material mainly composed of Ag in a plurality of parallel lines with a fixed interval, on the surface of the back glass substrate 411. The back glass substrate 411 employed here is made of soda glass, and has a thickness of about 2.6 mm.

The address electrode precursors 412a are sintered, to form the address electrodes 412.

To manufacture a PDP for a 40-inch class high-definition television, the interval between adjacent two address electrodes 412 needs to be set at about 0.36 mm or less.

Following this, the entire surface of the back glass substrate 411 on which the address electrodes 412 are formed is coated with a lead glass paste. The back glass substrate 411 is then placed on a setter and is baked, to form the dielectric layer 413 with a thickness of about 20 to 30 μm.

Further, by such a coating method as die coating, a paste material for barrier ribs mainly composed of lead glass and to which alumina powder is added as an aggregate is applied on the dielectric layer 413, and an area of the applied paste material other than an area corresponding to a desired shape is shaved off by sandblasting, to form precursors of barrier ribs (hereafter referred to as “barrier rib precursors 414a”). The barrier rib precursors 414a are then baked, to form the barrier ribs 414 each with a height of about 100 to 150 μm.

It should be noted here that the interval between adjacent barrier ribs 414 is about 0.36 mm.

Following this, a phosphor ink containing one of R, G, and B phosphors is applied on the wall surface of each barrier rib groove, i.e., the wall surface part of adjacent barrier ribs 414 and the surface part of the dielectric layer 413 exposed between the adjacent barrier ribs 414.

The applied phosphor ink of each color is dried and then baked, so that the R, G, and B phosphor layers 415 are formed.

The following are the phosphor materials used to form the phosphor layers 415 in the present embodiment:

| | |
|---|---|
| red phosphor | (YₓGd₁₋ₓ)BO₃:Eu |
| green phosphor | Zn₂SiO₄:Mn |
| blue phosphor | BaMgAl₁₀O₁₇:Eu³⁺ |

Using conventional manufacturing techniques for PDPs, the front plate 390 and the back plate 391 formed as described above are combined together and sealed, impure gas inside is evacuated, and a discharge gas is enclosed, to complete the PDP 400.

The PDP manufacturing method of the present invention is specifically a method for manufacturing the front plate 390, in particular a method for forming the multilayer electrodes 409. Therefore, manufacturing processes subsequent to the process of combining the front plate 390 and the back plate 391 are not described in detail.

The following describes the reasons that thin parts are provided at both ends of each multilayer electrode 409.

<Effects Produced by the Thin Parts>

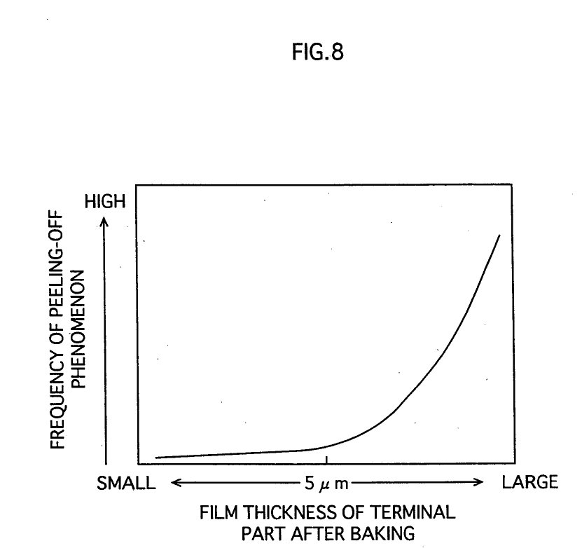

As shown in FIG. 8, the inventors examined the relationship between (a) the thickness of the multilayer electrode obtained by baking the multilayer electrode precursor immediately after developing and (b) the frequency of the electrode peeling-off phenomenon. The inventors then discovered that the electrode peeling-off phenomenon occurs frequently when the thickness of the obtained multilayer electrode is more than 5 μm, and the frequency of the electrode peeling off phenomenon becomes low when the thickness of the obtained multilayer electrode is 5 μm or less.

This can be considered due to the following reasons. When the film thickness of the multilayer electrode after baking is 5 μm or less, a shearing stress at the contact surface of the end part of the multilayer electrode with the front glass substrate is equal to or smaller than an adhesion strength per unit area of the contact surface.

In view of this, the film thickness of the multilayer electrode after baking may be uniformly set at 5 μm or less. However, if the film thickness of the multilayer electrode after baking is uniformly set at such a small value, a resistance of the multilayer electrode increases accordingly. This creates a new problem that high power is required for the PDP device.

In particular, the width of a part of multilayer electrodes that is included in an area where cells are arranged (hereafter referred to as a “display area”) needs to be minimized, in view of not disturbing traveling of light toward the front side of the front plate 390 when the cells are lit. With such a narrow width required, a reduced film thickness of the multilayer electrode part included in the display area directly increases the resistance of the entire multilayer electrode.

Therefore, it is extremely difficult to consider setting the film thickness of the multilayer electrode at 5 μm or less in the above-described display area.

The inventors made further efforts in finding a solution, and discovered that the above-mentioned shearing stress is particularly large in an area of the multilayer electrode from the end face of the end part to a position that is about 10 μm from the end face in the X-axis direction.

Accordingly, the inventors discovered that the frequency of the electrode peeling-off phenomenon can be lowered, by reducing a film thickness of the multilayer electrode, at its end part, to 5 μm or less, at least in the above-described area in the X-axis direction.

For the reasons described above, the inventors determined to form the multilayer electrode of the present invention so as to have, at its both ends, thin parts with a film thickness of 5 μm or less. In this way, the frequency of the electrode peeling-off phenomenon can be lowered, and at the same time, the electrodes can have a low resistance.

<Generation of Internal Stresses>

(Stresses in Conventional Multilayer Electrode)

The following describes how generation of stresses in the multilayer electrode having the above thin parts differs from generation of stresses in a conventional multilayer electrode.

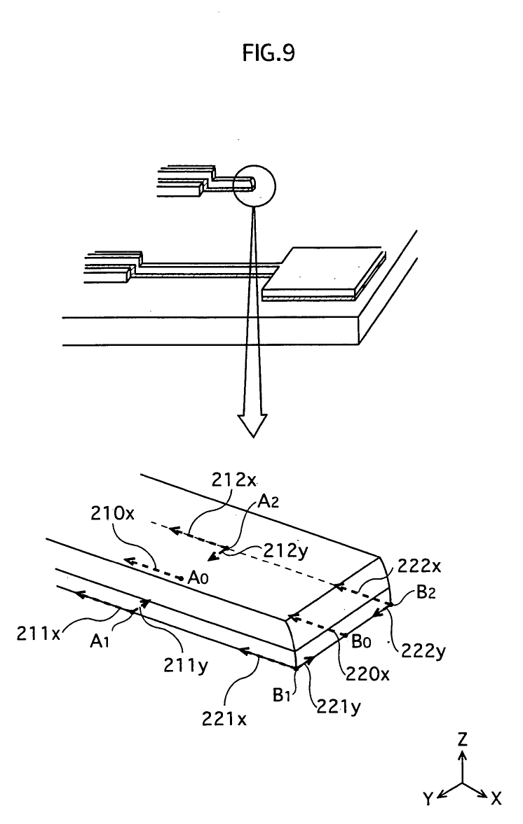

FIG. 9 shows stresses generated at the contact surface between the front glass substrate 401 and the multilayer electrode 309b in the conventional PDP 100.

The following describes such stresses generated at the contact surface, focusing on points A₀, A₁, and A₂ as typical points away from the edge, and on points B₀, B₁, and B₂ as typical points at the edge.

The following describes stresses generated at these points.

At point A₀, a shearing stress 210x in the X-axis left direction is generated.

At point A₁, a shearing stress 211x in the X-axis left direction and a shearing stress 211y in the Y-axis upward direction are generated.

At point A₂, a shearing stress 212x in the X-axis left direction and a shearing stress 212y in the Y-axis downward direction are generated.

At point B₀, a shearing stress 220x in the X-axis left direction is generated.

At point B₁, a shearing stress 221x in the X-axis left direction and a shearing stress 221y in the Y-axis upward direction are generated.

At point B₂, a shearing stress 222x in the X-axis left direction and a shearing stress 222y in the Y-axis downward direction are generated.

Among these stresses generated, the shearing stress 220x, the shearing stress 221x, and the shearing stress 222x, i.e., shearing stresses in the X-axis direction at the edge are large.

The following describes the reasons that the shearing stresses in the X-axis direction at the edge are large.

The following first focuses on the force of shrinkage in the X-axis direction.

Assume here for example that the precursor of the multilayer electrode 309b is divided into two layers, an upper layer and a lower layer. The lower layer that is in contact with the front glass substrate 401 receives a force inverse to the force of shrinkage when the lower layer is shrunk in the X-axis direction. The received inverse force hinders the shrinkage and also causes internal stresses to be generated in the X-axis direction.

On the other hand, as compared with the lower layer, the upper layer whose upper surface is open is less likely to receive a force inverse to the force of shrinkage. Therefore, the upper layer is shrunk by a greater amount than the lower layer.

Here, the upper layer being shrunk by a greater amount than the lower layer naturally receives a force inverse to the force of shrinkage from the lower layer, and the received inverse force hinders the shrinkage of the upper layer. Therefore, despite being smaller than the internal stresses generated in the lower layer, internal stresses in the X-axis direction are generated in the upper layer as well.

In this way, the lower the layer, the larger the internal stresses in the X-axis direction generated therein.

The width of the precursor of the multilayer electrode 309b in the Y-axis direction is about 100 μm, with the width of the terminal part 108 being 500 μm.

On the other hand, the length of the precursor of the multilayer electrode 309b in the X-axis direction is, for example, as long as 900 mm in the case of a 42-inch class PDP.

Accordingly, with the shrinkage rate being the same in each direction, an amount of shrinkage in the X-axis direction is much larger than amounts of shrinkage in any other directions.

Such shrinkage by a large amount in the X-axis direction is particularly likely to occur in the end parts of the multilayer electrode 309b whose edge in the X-axis direction is open, rather than occurring at disperse positions on the multilayer electrode 309b.

Here, a difference in an amount of shrinkage between the upper layer and the lower layer is larger in the end parts of the multilayer electrode 309b than in any other parts of the multilayer electrode 309b. Therefore, shearing stresses generated in the X-axis direction in the end parts of the multilayer electrode 309b are large.

In short, the electrode peeling-off phenomenon is considered to be caused mainly by the shearing stresses generated in the X-axis direction in the end parts of the multilayer electrode.

Here, the precursor of the multilayer electrode 309b is actually shrunk in the Y-axis direction and the Z-axis direction as well. The following describes shrinkage occurring in the Y-axis direction and shrinkage occurring in the Z-axis direction.

When the precursor of the multilayer electrode 309b is shrunk in the Y-axis direction, the width of the precursor of the multilayer electrode 309b in the Y-axis direction is about 100 μm, with its terminal part 108 having a width of about 500 μm. Therefore, an amount of shrinkage in the Y-axis direction is small, and the shearing stresses generated in the Y-axis direction are smaller than the shearing stresses generated in the X-axis direction.

Also, for the shrinkage occurring in the Z-axis direction in the multilayer electrode 309b, a force inverse to the force of shrinkage in the Z-axis direction is not generated. Therefore, only little shearing stresses are generated in the Z-axis direction.

Therefore, the shearing stresses generated in the Z-axis direction in the multilayer electrode 309b do not cause the electrode peeling-off phenomenon.

(Stresses in Multilayer Electrode of the Invention)

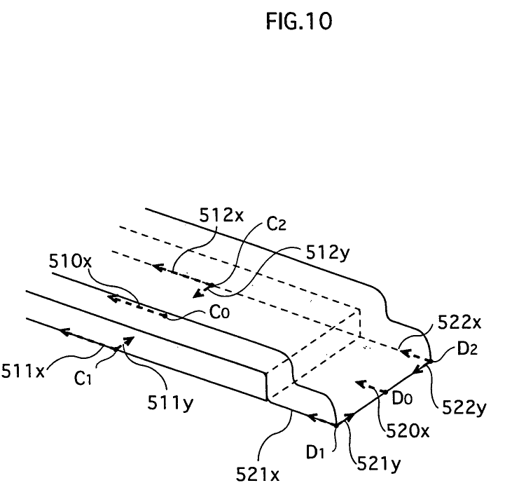

FIG. 10 is a diagram for explaining internal stresses generated, after baking, in the E part of the multilayer electrode 409b shown in FIG. 5.

The following describes such stresses generated at the contact surface between the multilayer electrode 409b and the front glass substrate 401, focusing on points C₀, C₁, and C₂ as typical points away from the edge, and on points D₀, D₁, and D₂ as typical points at the edge.

The following describes stresses generated at these points.

At point C₀, a shearing stress 510x in the X-axis left direction is generated.

At point C₁, a shearing stress 511x in the X-axis left direction and a shearing stress 511y in the Y-axis upward direction are generated.

At point C₂, a shearing stress 512x in the X-axis left direction and a shearing stress 512y in the Y-axis downward direction are generated.

At point D₀, a shearing stress 520x in the X-axis left direction is generated.

At point D₁, a shearing stress 521x in the X-axis left direction and a shearing stress 521y in the Y-axis upward direction are generated.

At point D₂, a shearing stress 522x in the X-axis left direction and a shearing stress 522y in the Y-axis downward direction are generated.

Among these stresses generated, the shearing stress 520x, the shearing stress 521x, and the shearing stress 522x are smaller than the shearing stresses in the X-axis direction at the edge of the conventional multilayer electrode, i.e., the shearing stresses 220x, 221x, and 222x described above.

This can be considered due to the following reasons.

The film thickness of the thin part 421, i.e., the edge of the end part of the multilayer electrode 409b, is 5 μm or less, and therefore a cross section of the thin part 421 on the Y-Z plane is smaller than that of the corresponding part of a conventional multilayer electrode. This means that the shrinking force in the X-axis left direction generated in the upper layer in the thin part 421 is smaller than the corresponding shrinking force in the conventional multilayer electrode.

Therefore, in the thin part 421, a shearing stress equal to or larger than an adhesion strength is less likely to be generated and therefore the electrode peeling-off phenomenon is less likely to occur.

On the other hand, the cross section on the Y-Z plane at the edge of the end part of the multilayer electrode 409b is larger as the film thickness at the edge is larger. Accordingly, the shrinking force in the X-axis left direction is larger as the film thickness at the edge of the end part of the multilayer electrode 409b is larger. When the film thickness at the edge of the end part of the multilayer electrode 409 is large, a shearing stress equal to or larger than an adhesion strength is generated.

As described above, according to the PDP manufacturing method relating to the first embodiment, the multilayer electrode 409 has a thin part with a thickness of 5 μm or less in an area from the end face of each end part of the multilayer electrode 409 to a position that is 10 μm from the end face in the longitudinal direction. The presence of such a thin part reduces shearing stresses generated at the edges of the end parts of the multilayer electrode 409, thereby preventing the electrode peeling-off phenomenon from occurring.

Although according to the manufacturing method for the PDP 400 relating to the first embodiment, the nega-type photosensitive paste 702a is applied on the front glass substrate 401 by screen printing, the present invention should not be limited to such. A lamination method for applying a film material as the photosensitive material may be employed instead of screen printing. With the lamination method, too, the same effects as described above can be produced by providing the thin parts in the above-described shape.

Also, although the first embodiment describes the case where the photosensitive paste 702a and the photosensitive paste 703a are of nega-type, the present invention should not be limited to such.

Further, although the first embodiment describes the case where the photosensitive paste 702a and the photosensitive paste 703a are made of different components, the photosensitive paste 702a and the photosensitive paste 703a may be made of the same components.

Moreover, although the first embodiment describes the case where the photosensitive paste 702a contains ruthenium oxide, the present invention should not be limited to such.

Also, although the first embodiment describes the case where the front glass substrate 401 on which the multilayer electrodes 409 are formed is made of soda glass, the present invention should not be limited to such. The front glass substrate 401 may be made of any materials that are at least heat resistant at the baking temperature and have a predetermined transparency.

Further, the transparent electrodes and the like may be formed in advance on the substrate made of glass or the like.

The first embodiment describes the case where drying after printing is performed using an IR furnace whose temperature profile has a linear heating from a room temperature to a temperature in a range of 80 to 120° C. inclusive, and then has a plateau at the reached temperature. However, the present invention should not be limited to such. The drying may be performed using a device other than the IR furnace, and also may employ a device with a temperature profile different from the above temperature profile of the IR furnace.

Also, the first embodiment describes the case where the condition of exposure employed is such that a luminance is in a range of 5 to 20 mW/cm², an accumulated quantity of light is in a range of 100 to 600 mJ/cm², and a proxy amount is in a range of 50 to 250 μm. However, the present invention should not be limited to such values.

Although the first embodiment describes the case where the developer used contains 0.3 to 0.5 wt % of sodium carbonate, the present invention should not be limited to such values.

Although the first embodiment describes the case where the multilayer electrode 409 is formed by baking using a continuous belt furnace with a peak temperature in a range of 550 to 600° C. (preferably in a range of 580 to 600° C.), the present invention should not be limited to such. The other temperature range may be employed, and also, a device other than the continuous belt furnace may be employed.

[Second Embodiment]

A PDP 800 relating to a second embodiment of the present invention differs from the PDP 400 only in a method for forming multilayer electrodes. Therefore, the explanation common to the PDP 400 is omitted here. The following describes the method for forming multilayer electrodes in the second embodiment, which differs from the method employed in the first embodiment.

<Method for Forming the Multilayer Electrodes>

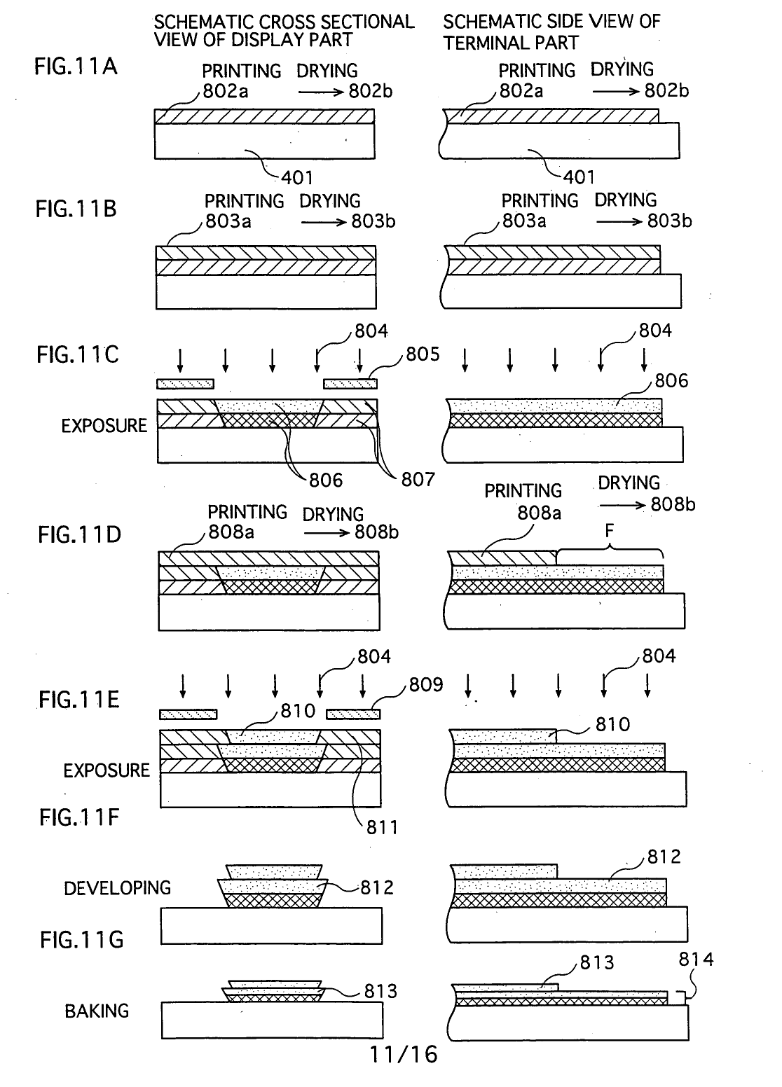

FIGS. 11A to 11G are diagrams for explaining the method for forming multilayer electrodes in the PDP 800 relating to the second embodiment.

For ease of explanation, the following assumes that the E part of the multilayer electrode 409b is formed as shown in FIG. 5 using the multilayer electrode forming method relating to the second embodiment.

First, a black nega-type photosensitive paste 802a containing ruthenium oxide particles is applied on the front glass substrate 401 by screen printing. Then, the front glass substrate 401 on which the photosensitive paste 802a is applied is dried using an IR furnace whose temperature profile has a linear heating from a room temperature to a temperature in a range of 80 to 120° C. inclusive, and then has a plateau of a fixed period of time at the reached temperature. Due to this drying, solvents and the like are removed from the nega-type photosensitive paste 802a, to form a black electrode film precursor 802b (FIG. 11A).

Here, a range corresponding to the thin part 421 is included in the range where the nega-type photosensitive paste 802a is printed.

Following this, a nega-type photosensitive paste 803a containing Ag particles is applied, by screen printing, on the black electrode film precursor 802b formed on the front glass substrate 401. The front glass substrate 401 on which the black electrode film precursor 802b is formed and the photosensitive paste 803a is applied is dried using an IR furnace whose temperature profile is the same as the temperature profile described above. Due to this drying, solvents and the like are reduced from the photosensitive paste 803a, to form a bus electrode precursor 803b (FIG. 11B).

Here, a range corresponding to the thin part 421 is included in the range where the nega-type photosensitive paste 803a is printed.

Following this, an exposure mask 805 is placed on the bus electrode precursor 803b. The front glass substrate 401 on which the black electrode film precursor 802b and the bus electrode precursor 803b are formed is exposed to ultraviolet rays 804 through the exposure mask 805. This causes a cross-linking reaction in the vicinity of the film surface of the bus electrode precursor 803b, and the cross-linking reaction proceeds to downward layer parts. The parts where the cross-linking reaction occurs are polymerized, resulting in exposed parts 806 and unexposed parts 807 being formed (FIG. 11C).

It should be noted here that the condition of exposure employed here is the same as the condition employed in the first embodiment.

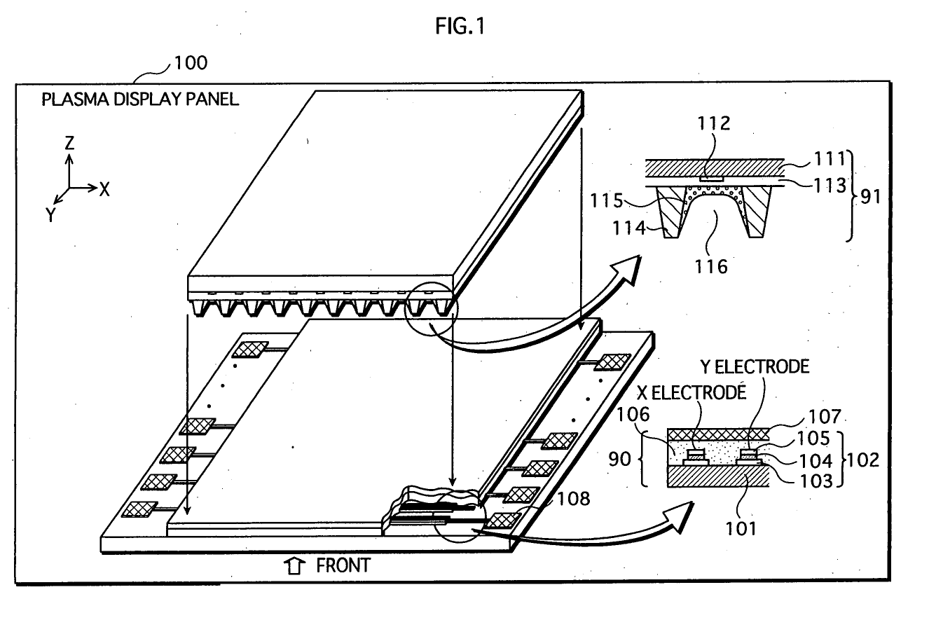

Following this, a nega-type photosensitive paste 808a containing Ag particles is applied, by screen printing, in a range excluding the range F that corresponds to the thin part 421 on the bus electrode precursor 803b formed on the front glass substrate 401. The front glass substrate 401 on which the bus electrode precursor 803b and the like are formed and the photosensitive paste 808a is applied is dried using an IR furnace whose temperature profile is the same as described above. Due to this drying, solvents and the like are reduced from the photosensitive paste 808a, to form the bus electrode precursor 808b (FIG. 1D).

Following this, an exposure mask 809 is placed on the bus electrode precursor 808b. The front glass substrate 401 on which the bus electrode precursor 808b is formed is then exposed to ultraviolet rays 804 through the exposure mask 809. This causes a cross-linking reaction in the vicinity of the film surface of the bus electrode precursor 808b, and the cross-linking reaction proceeds to downward layer parts. The parts where the cross-linking reaction occurs are polymerized, resulting in exposed parts 810 and unexposed parts 811 being formed (FIG. 11E).

It should be noted here that the condition of exposure employed here is the same as the condition employed in FIG. 11c.

Following this, the front glass substrate 401 on which the black electrode film precursor 802b, the bus electrode precursor 803b, and the bus electrode precursor 808b are formed is developed using a developer containing 0.3 to 0.5 wt % of sodium carbonate, so that the unexposed parts 807 and the unexposed parts 811 are removed. As a result, the exposed parts, i.e., the patterned parts, remain on the front glass substrate 401, to form a multilayer electrode precursor 812 (FIG. 11F).

Following this, the front glass substrate 401 on which the multilayer electrode precursor 812 is formed is baked using a continuous belt furnace with a peak temperature in a range of 550 to 600° C. (preferably in a range of 580 to 600° C.) Due to the baking, in the multilayer electrode precursor 812, the resin elements etc. burn out and vaporize, the glass frit melts, and the conductive material sinters, to form a multilayer electrode 813 (FIG. 11G).

Due to this sintering, the multilayer electrode precursor 812 reduces its apparent volume, wire width, and film thickness, to become the multilayer electrode 813.

Here, the film thickness 814 of the thin part 421 is 5 μm or less.

As described above, according to the manufacturing method for the PDP 800 relating to the second embodiment, the multilayer electrode has, at its each end part, the thin part 421 with a film thickness of 5 μm or less, as is the case with the PDP manufacturing method relating to the first embodiment. The presence of such a thin part reduces shearing stresses in the X-axis direction generated at the edges of the end parts of the multilayer electrode, thereby preventing the electrode peeling-off phenomenon from occurring at the time of baking.

It should be noted here that the method for forming the multilayer electrode 813 relating to the second embodiment may further include a developing process, after the exposure process shown in FIG. 11C, employing the same condition as the condition employed in the developing process in FIG. 11F and moreover a baking process, after this developing process, employing the same condition as the condition employed in the baking process shown in FIG. 11G, and the process shown in FIG. 11D and subsequent processes may be carried out after this baking process.

Also, the range where the photosensitive paste 808a is printed may include the range F in the printing process shown in FIG. 11D, and in this case, the exposure mask may be placed to cover the range F in the exposure process shown in FIG. 11E. In this case, too, the same multilayer electrode 813 as described above can be formed.

Although according to the manufacturing method for the PDP 800 relating to the second embodiment the nega-type photosensitive paste 802a is applied on the front glass substrate 401 by screen printing, the present invention should not be limited to such. A lamination method for applying a film material as the photosensitive material may be employed instead of screen printing. With the lamination method, too, the same effects as described above can be produced by providing the thin parts in the above-described shape.

Also, although the second embodiment describes the case where the photosensitive paste 802a, the photosensitive paste 803a, and the photosensitive paste 808a are of nega-type, the present invention should not be limited to such.

Further, although the second embodiment describes the case where the photosensitive paste 803a and the photosensitive paste 808a are made of the same components, which are different from the components of the photosensitive paste 802a, the present invention should not be limited to such. For example, all of these photosensitive pastes may be made of the same components.

Moreover, although the second embodiment describes the case where the photosensitive paste 802a contains ruthenium oxide and Ag, the present invention should not be limited to such.

Also, the second embodiment describes the case where drying after printing is performed using an IR furnace whose temperature profile has a linear heating from a room temperature to a temperature in a range of 80 to 120° C. inclusive, and then has a plateau at the reached temperature. However, the present invention should not be limited to such. The drying may be performed using a device other than the IR furnace, and also may employ a device with a temperature profile different from the above temperature profile of the IR furnace.

Also, the second embodiment describes the case where the condition of exposure employed is such that a luminance is in a range of 5 to 20 mW/cm², an accumulated quantity of light is in a range of 100 to 600 mJ/cm², and a proxy amount is in a range of 50 to 250 μm. However, the present invention should not be limited to such values.

Although the second embodiment describes the case where the developer used contains 0.3 to 0.5 wt % of sodium carbonate, the present invention should not be limited to such values.

Although the second embodiment describes the case where the multilayer electrode 409 is formed by baking using a continuous belt furnace with a peak temperature in a range of 550 to 600° C. (preferably in a range of 580 to 600° C.), the present invention should not be limited to such. The other temperature range may be employed, and also, a device other than the continuous belt furnace may be employed.

[Third Embodiment]

A PDP 900 relating to a third embodiment of the present invention differs from the PDP 400 only in a method for forming multilayer electrodes. Therefore, the explanation common to the PDP 400 is omitted here. The following describes the method for forming multilayer electrodes in the third embodiment, which differs from the method employed in the first embodiment.

<Method for Forming the Multilayer Electrodes>

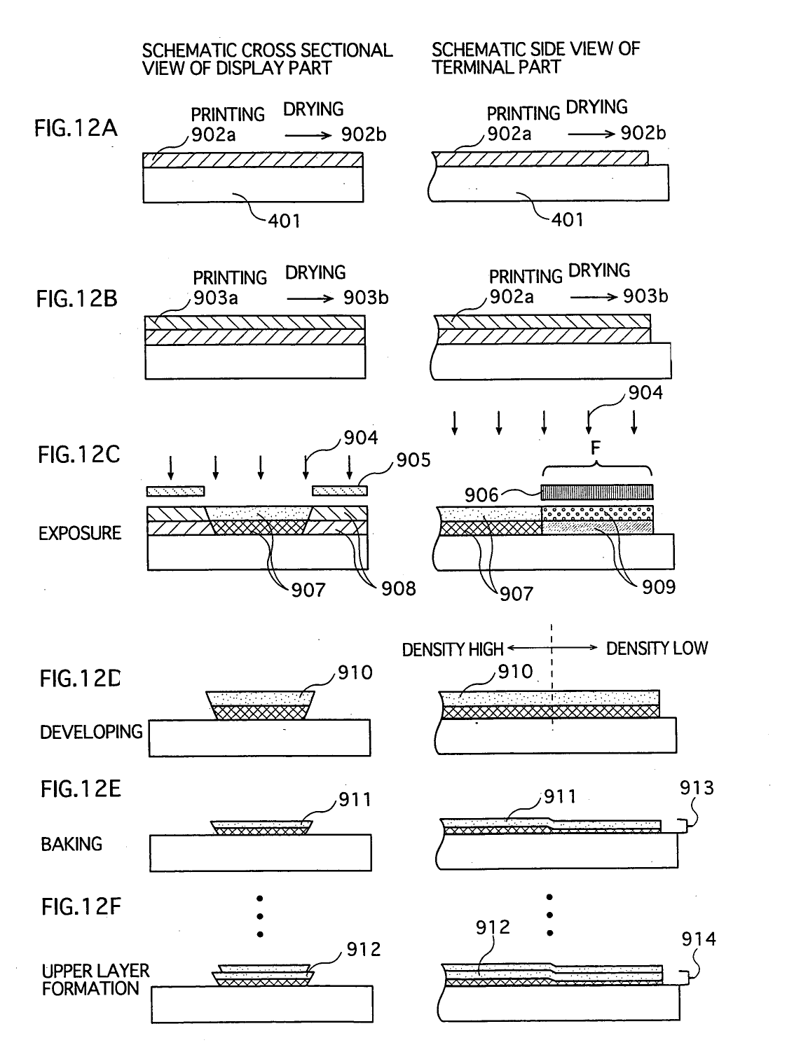

FIGS. 12A to 12F are diagrams for explaining the method for forming multilayer electrodes in the PDP 900 relating to the third embodiment.

For ease of explanation, the following assumes that the E part of the multilayer electrode 409b is formed as shown in FIG. 5 using the multilayer electrode forming method relating to the third embodiment.

First, a black nega-type photosensitive paste 902a containing ruthenium oxide particles is applied on the front glass substrate 401 by screen printing. Then, the front glass substrate 401 on which the photosensitive paste 902a is applied is dried using an IR furnace whose temperature profile has a linear heating from a room temperature to a temperature in a range of 80 to 120° C. inclusive, and then has a plateau of a fixed period of time at the reached temperature. Due to this drying, solvents and the like are removed from the nega-type photosensitive paste 902a, to form a black electrode film precursor 902b (FIG. 12A)

Here, a range corresponding to the thin part 421 is included in the range where the nega-type photosensitive paste 902a is applied.

Following this, a nega-type photosensitive paste 903a containing Ag particles is applied, by screen printing, on the black electrode film precursor 902b formed on the front glass substrate 401. The front glass substrate 401 on which the black electrode film precursor 902b is formed and the photosensitive paste 903a is applied is dried using an IR furnace whose temperature profile is the same as the temperature profile described above. Due to this drying, solvents and the like are reduced from the photosensitive paste 903a, to form a bus electrode precursor 903b (FIG. 12B).

Here, a range corresponding to the thin part 421 is included in the range where the photosensitive paste 903a is printed.

Following this, an exposure mask 905 having a halftone part 906 in the range F corresponding to the thin part 421 is placed on the bus electrode precursor 903b. In the halftone part 906, a plurality of lines each with a width of 10 μm are arranged at intervals of 10 μm. The front glass substrate 401 on which the black electrode film precursor 902b and bus electrode precursor 903b are formed is exposed to ultraviolet rays 904 through the exposure mask 905. This causes a cross-linking reaction in the vicinity of the film surface of the bus electrode precursor 903b, and the cross-linking reaction proceeds to downward layer parts. The parts where the cross-linking reaction occurs are polymerized, resulting in exposed parts 907, unexposed parts 908, and semiexposed parts 909 being formed. The semiexposed parts 909 have resulted from exposure to the ultraviolet rays 904 that have passed through the halftone part 906. Therefore, the semiexposed parts 909 are parts where the cross-linking reaction proceeds moderately, i.e., parts where the cross-linking reaction proceeds by a less greater degree than in the exposed parts 907 (FIG. 12C).

It should be noted here that the condition of exposure employed here is such that a luminance is in a range of 5 to 20 mW/cm², an accumulated quantity of light is in a range of 100 to 600 mJ/cm², and a proxy amount is in a range of 50 to 250 μm.

Following this, the front glass substrate 401 on which the black electrode film precursor 902b and the bus electrode precursor 903b are formed is developed using a developer containing 0.3 to 0.5 wt % of sodium carbonate, so that the unexposed parts 908 are removed. As a result, the exposed parts and the semi-exposed parts, i.e., the patterned parts, remain on the front glass substrate 401 to form a multilayer electrode precursor 910.

Due to the developing, in the semiexposed parts 909 of the multilayer electrode precursor 910, micro portions of the material that have not been completely polymerized are removed. Therefore, the resulting semiexposed parts 909 have a lower density of the electrode material per unit volume than the exposed parts 907 (FIG. 12D).

Following this, the front glass substrate 401 on which the multilayer electrode precursor 910 is formed is baked using a continuous belt furnace with a peak temperature in a range of 550 to 600° C. (preferably in a range of 580 to 600° C.). Due to the baking, in the multilayer electrode precursor 910, the resin elements etc. burn out and vaporize, the glass frit melts, and the conductive material sinters, to form a multilayer electrode 911 (FIG. 12E).

Due to this sintering, the multilayer electrode precursor 910 reduces its apparent volume, wire width, and film thickness, to become the multilayer electrode 911.

Here, the semiexposed parts 909 with a low density reduce its volume by a greater degree than the exposed parts 907, so that the film thickness 913 of the multilayer electrode 911 in the range F corresponding to the thin part 421 is 5 μm or less.

The following describes the reasons that the exposure using a halftone exposure mask (hereafter referred to as “halftone exposure”) can reduce the film thickness as described above.

The type of an exposure mask used at the time of exposure, specifically the line width and line interval of the exposure mask, has an influence on the degree of precision of a pattern formed. When the line width is large, a pattern precisely matching the pattern of the exposure mask can be formed. When the line width is small, the exposure sensitivity is not reached and therefore the cross-linking reaction becomes extremely weak.

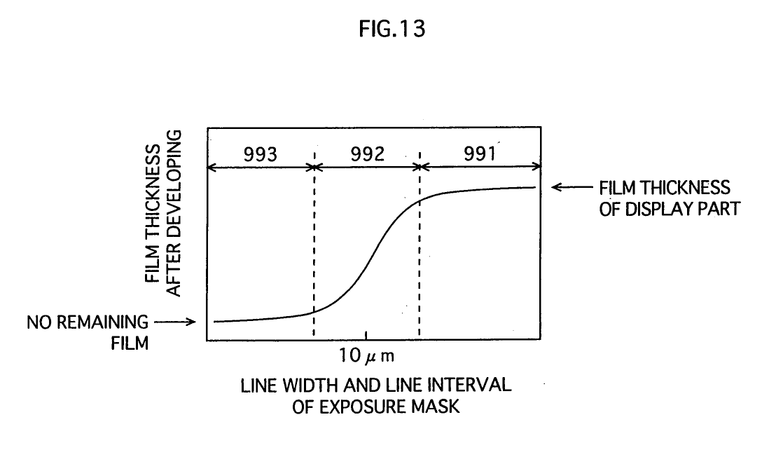

FIG. 13 shows the relationship between (a) a pattern of a halftone exposure mask (where a line width is set equal to a line interval) and (b) a film thickness after developing, when such a photosensitive material as the photosensitive paste 902a and the photosensitive paste 903a is subjected to halftone exposure, with a proxy amount being 100 μm.

In the figure, an area where a halftone exposure mask has a wide line width and a large line interval is referred to as an exposed area 991. In the exposed area 991, a pattern precisely matching the pattern of the mask is formed.

An area where a halftone exposure mask has a narrow line width and a small line interval is referred to as an unexposed area 993. In the unexposed area 993, a cross-linking reaction to occur only slightly.

An area provided between the exposed area 991 and the unexposed area 993 is referred to as a halftone area 992. In the halftone area 992, a cross-linking reaction occurs and proceeds by a less greater degree than in the exposed area 993 and so incomplete developing is carried out.

By carrying out the exposure employing such a halftone exposure mask to fall within the halftone area 992, i.e., a halftone exposure mask with a line width and a line interval being about 10 μm, the multilayer electrode precursor is developed incompletely, thereby enabling the film thickness to be reduced.

Here, to realize the above-described halftone exposure, a proxy amount needs to be set to provide a certain space between the halftone exposure mask and the photosensitive paste.

As described above, according to the manufacturing method for the PDP 900 relating to the third embodiment, the multilayer electrode has, at its each end part, the thin part 421 with a film thickness of 5 μm or less, as is the case with the PDP manufacturing methods relating to the first and second embodiments. The presence of such a thin part prevents the electrode peeling-off phenomenon from occurring at the time of baking.

To further lower a resistance of the multilayer electrode 911, another layer of the same material as the photosensitive paste 903a may be laminated, by printing, on the multilayer electrode 911 formed on the front glass substrate 401. In this case, the newly generated multilayer electrode 912 (FIG. 12F) after going through the lamination processes shown in FIGS. 12B to 12E should be such that the film thickness 914 of the thin part 421 after baking is 5 μm or less. With the film thickness 914 being 5 μm or less, the thin part 421 can produce the effect of preventing the electrode peeling-off phenomenon.

In this case of another layer of the photosensitive paste 903a, too, the above-described halftone part 906 may be employed at the time of exposure of the photosensitive paste 903a applied in the range F.

[Fourth Embodiment]

A PDP 1000 relating to a fourth embodiment of the present invention differs from the PDP 400 only in a method for forming multilayer electrodes. Therefore, the explanation common to the PDP 400 is omitted here. The following describes the method for forming multilayer electrodes in the fourth embodiment, which differs from the method employed in the first embodiment.

<Method for Forming the Multilayer Electrodes>

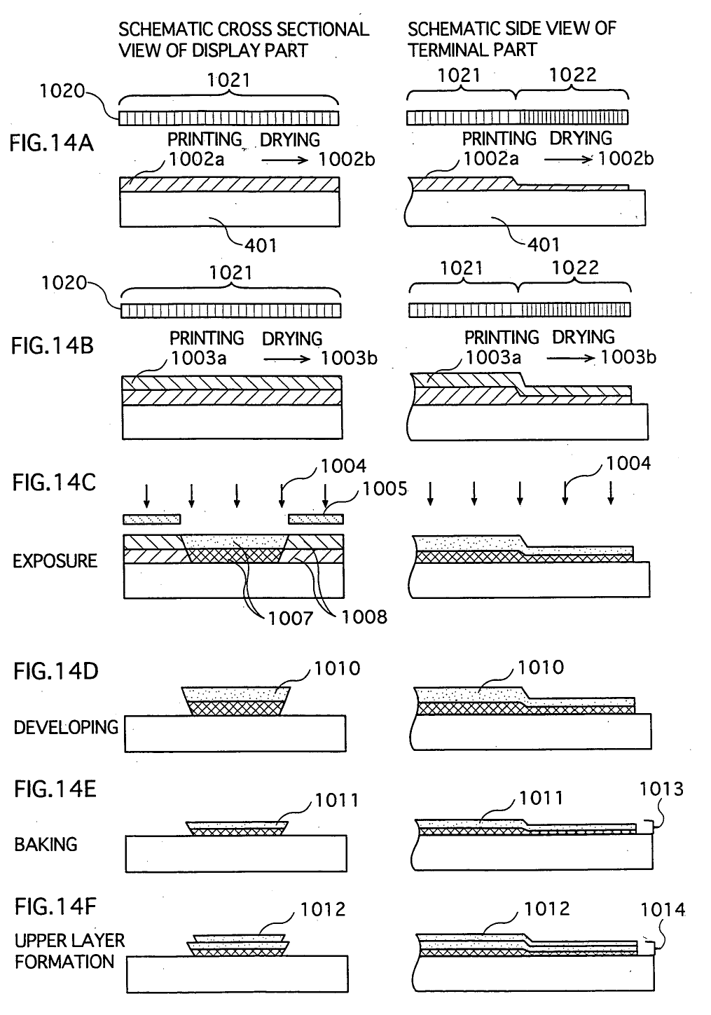

FIGS. 14A to 14F are diagrams for explaining the method for forming multilayer electrodes in the PDP 1000 relating to the fourth embodiment.

For ease of explanation, the following assumes that the E part of the multilayer electrode 409b is formed as shown in FIG. 5 using the multilayer electrode forming method relating to the fourth embodiment.

First, a black nega-type photosensitive paste 1002a containing ruthenium oxide particles is applied on the front glass substrate 401 by printing, using a screen 1020 that has the following characteristics.

The screen 1020 used for the printing has a first area 1021 with a high opening ratio, and a second area 1022 with a low opening ratio.

To be more specific, the first area 1021 is formed by a screen with 334 mesh/inch, a fabric thickness of 40 μm, and an opening ratio of 33%, whereas the second area 1022 is formed by a screen with 380 mesh/inch, a fabric thickness of 40 μm, and an opening ratio of 32%.

In the second area 1022 with the opening ratio being low, the film thickness after printing is smaller than that in the first area 1021 with the opening ratio being high.

With this screen 1020 including the first area 1021 and the second area 1022, a thick part and a thin part of the photosensitive paste can be formed at once by carrying out printing once.

It should be noted here that at the time of printing the second area 1022 is positioned where the thin part 421 is to be formed.

Then, the front glass substrate 401 on which the photosensitive paste 1002a is applied is dried using an IR furnace whose temperature profile has a linear heating from a room temperature to a temperature in a range of 80 to 120° C. inclusive, and then has a plateau of a fixed period of time at the reached temperature. Due to this drying, solvents and the like are removed from the nega-type photosensitive paste 1002a, to form a black electrode film precursor 1002b (FIG. 14A).

Following this, using the screen 1020, a nega-type photosensitive paste 1003a containing Ag particles is applied, by screen printing, on the black electrode film precursor 1002b formed on the front glass substrate 401. The front glass substrate 401 on which the black electrode film precursor 1002b is formed and the photosensitive paste 1003a is applied is dried using an IR furnace whose temperature profile is the same as the temperature profile described above. Due to this drying, solvents and the like are reduced from the photosensitive paste 1003a, to form a bus electrode precursor 1003b (FIG. 14B).

It should be noted here that at the time of printing the second area 1022 is also positioned where the thin part 421 is to be formed.

Following this, a normal exposure mask 1005 is placed on the bus electrode precursor 1003b. The front glass substrate 401 on which the black electrode film precursor 1002b and bus electrode precursor 1003b are formed is exposed to ultraviolet rays 1004 through the exposure mask 1005. This causes a cross-linking reaction in the vicinity of the film surface of the bus electrode precursor 1003b, and the cross-linking reaction proceeds to downward layer parts. The parts where the cross-linking reaction occurs are polymerized, resulting in exposed parts 1007 and unexposed parts 1008 being formed (FIG. 14C).

It should be noted here that the condition of exposure employed here is such that a luminance is in a range of 5 to 20 mW/cm², an accumulated quantity of light is in a range of 100 to 600 mJ/cm², and a proxy amount is in a range of 50 to 250 μm.

Following this, the front glass substrate 401 on which the black electrode film precursor 1002b and the bus electrode precursor 1003b are formed is developed using a developer containing 0.3 to 0.5 wt % of sodium carbonate, so that the unexposed parts 1008 are removed. As a result, the exposed parts, i.e., the patterned parts, remain on the front glass substrate 401 to form a multilayer electrode precursor 1010 (FIG. 14D).

Following this, the front glass substrate 401 on which the multilayer electrode precursor 1010 is formed is baked using a continuous belt furnace with a peak temperature in a range of 550 to 600° C. (preferably in a range of 580 to 600° C.). Due to the baking, in the multilayer electrode precursor 1010, the resin elements etc. burn out and vaporize, the glass frit melts, and the conductive material sinters, to form a multilayer electrode 1011 (FIG. 14E).

Due to this sintering, the multilayer electrode precursor 1010 reduces its apparent volume, wire width, and film thickness, to become the multilayer electrode 1011.

Here, the film thickness 1013 of the multilayer electrode 1011 in the range F corresponding to the thin part 421 is 5 μm or less.

As described above, according to the manufacturing method for the PDP 1000 relating to the fourth embodiment, the multilayer electrode 911 has, at its each end part, the thin part 421 with a film thickness of 5 μm or less, as is the case with the PDP manufacturing methods relating to the first, second, and third embodiments. The presence of such a thin part reduces shearing stresses in the X-axis direction generated at the edges of the end parts of the multilayer electrode, thereby preventing the electrode peeling-off phenomenon from occurring at the time of baking.

To further lower a resistance of the multilayer electrode 1011, another layer of the same material as the photosensitive paste 1003a may be laminated, by printing, on the multilayer electrode 1011 formed on the front glass substrate 401. In this case, the newly generated multilayer electrode 1012 (FIG. 14F) after going through the lamination processes shown in FIGS. 14B to 14E should be such that the film thickness 1014 of the thin part 421 after baking is 5 μm or less. With the film thickness 1014 being 5 μm or less, the thin part 421 can produce the effect of preventing the electrode peeling-off phenomenon.

Although the fourth embodiment describes the case where the first area 1021 of the screen 1020 used for screen printing is formed by a screen with 334 mesh/inch, a fabric thickness of 45 μm, and an opening ratio of 33%, and the second area 1022 of the screen 1020 is formed by a screen with 380 mesh/inch, a fabric thickness of 40 μm, and an opening ratio of 32%, the present invention should not be limited to such. For example, one type of screen with 334 mesh/inch, a fabric thickness of 45 μm, and an opening ratio of 33% maybe used for the screen 1020. In this case, the adjustment of the print amount, i.e., the adjustment of the film thickness of the printed object may be performed by subjecting the second area 1022 to such processing as calendering for reducing the fabric thickness by applying pressure using a roller or the like, and subjecting the first area 1021 to no processing.

In this case, the above calendering is to be carried out in such a manner that the film thickness of the resulting printed object is substantially the same as the film thickness of the printed object in the case of using the above screen with 380 mesh/inch, a fabric thickness of 40 μm, and an opening ratio of 32%. Also, the opening ratios employed in the fourth embodiment are mere examples, and screens with other opening ratios can be employed depending on the components, viscosity, etc. of the photosensitive paste.

[Fifth Embodiment]

A PDP 1100 relating to a fifth embodiment of the present invention differs from the PDP 400 only in a method for forming multilayer electrodes. Therefore, the explanation common to the PDP 400 is omitted here. The following describes the method for forming multilayer electrodes in the fifth embodiment, which differs from the method employed in the first embodiment.

<Method for Forming the Multilayer Electrodes>

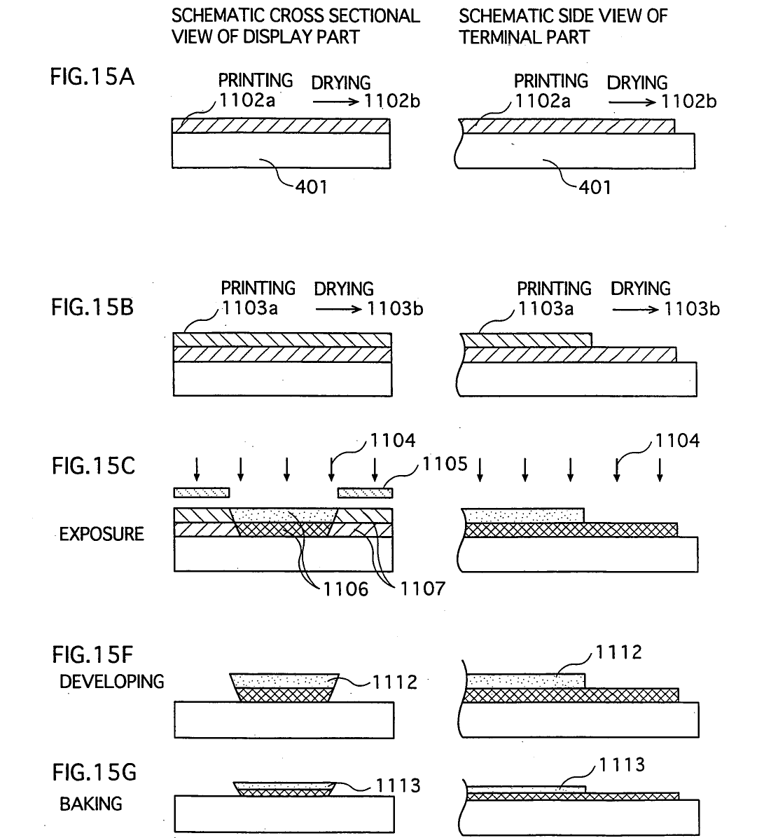

FIGS. 15A to 15G are diagrams for explaining the method for forming multilayer electrodes in the PDP 1100 relating to the fifth embodiment.

For ease of explanation, the following assumes that the E part of the multilayer electrode 409b is formed as shown in FIG. 5 using the multilayer electrode forming method relating to the fifth embodiment.

First, a black nega-type photosensitive paste 1102a containing ruthenium oxide particles is applied on the front glass substrate 401 by screen printing. Then, the front glass substrate 401 on which the photosensitive paste 1102a is applied is dried using an IR furnace whose temperature profile has a linear heating from a room temperature to a temperature in a range of 80 to 120° C. inclusive, and then has a plateau of a fixed period of time at the reached temperature. Due to this drying, solvents and the like are removed from the nega-type photosensitive paste 1102a, to form a black electrode film precursor 1102b (FIG. 15A).

Here, a range corresponding to the thin part 421 is included in the range where the photosensitive paste 1102a is printed.

Following this, a nega-type photosensitive paste 1103a containing Ag particles is applied, by screen printing, on the black electrode film precursor 1102b formed on the front glass substrate 401. The front glass substrate 401 on which the black electrode film precursor 1102b is formed and the photosensitive paste 1103a is applied is dried using an IR furnace whose temperature profile is the same as the temperature profile described above. Due to this drying, solvents and the like are reduced from the photosensitive paste 1103a, to form a bus electrode precursor 1103b (FIG. 15B).

Here, although the range corresponding to the thin part 421 is included in the range where the photosensitive paste containing Ag particles is printed for laminating the second layer according to the PDP manufacturing methods relating to the first, second, third, and fourth embodiments, the range corresponding to the thin part 421 is not included in the range where the photosensitive paste containing Ag particles is printed for laminating the second layer according to the PDP manufacturing method relating to the fifth embodiment.

Following this, an exposure mask 1105 is placed on the bus electrode precursor 1103b. The front glass substrate 401 on which the black electrode film precursor 1102b and bus electrode precursor 1103b are formed is exposed to ultraviolet rays 1104 through the exposure mask 1105. This causes a cross-linking reaction in the vicinity of the film surface of the bus electrode precursor 1103b, and the cross-linking reaction proceeds to downward layer parts. The parts where the cross-linking reaction occurs are polymerized, resulting in exposed parts 1106 and unexposed parts 1107 being formed (FIG. 15C).

Following this, the front glass substrate 401 on which the black electrode film precursor 1102b and the bus electrode precursor 1103b are formed is developed using a developer containing 0.3 to 0.5 wt % of sodium carbonate, so that the unexposed parts 1107 are removed. As a result, the exposed parts 1106 remain on the front glass substrate 401, to form a multilayer electrode precursor 1112 (FIG. 15D).

Following this, the front glass substrate 401 on which the multilayer electrode precursor 1112 is formed is baked using a continuous belt furnace with a peak temperature in a range of 550 to 600° C. (preferably in a range of 580 to 600° C.). Due to the baking, in the multilayer electrode precursor 1112, the resin elements etc. burn out and vaporize, the glass frit melts, and the conductive material sinters, to form a multilayer electrode 1113 (FIG. 15E).

Due to this sintering, the multilayer electrode precursor 1112 reduces its apparent volume, wire width, and film thickness, to become the multilayer electrode 1113.

Here, the thin part 421 is formed only by one layer, i.e., the black electrode film 404 obtained by baking the black electrode film precursor 1102b. The thin part 421 has a smaller thickness than the other parts of the multilayer electrode 1113 formed by two layers, i.e., the black electrode film 404 and the bus electrode 405. The thin part 421 specifically has a thickness of 5 μm or less.

As described above, according to the manufacturing method for the PDP 1100 relating to the fifth embodiment, the multilayer electrode has, at its each end part, the thin part 421 with a film thickness of 5 μm or less, as is the case with the PDP manufacturing methods relating to the first, second, third, and fourth embodiments. The presence of such a thin part prevents the electrode peeling-off phenomenon from occurring.

It should be noted here that because the black electrode film 404 that singly forms the thin part 421 is mainly composed of ruthenium oxide with a lower conductivity than the bus electrode 405, it is preferable to provide the thin part 421 in a relatively small range.

Also, a method for laminating another layer on the bus electrode 405, using the same material as the material for the bus electrode 405 may be employed to further lower a resistance of the entire electrode.

[Sixth Embodiment]

A PDP 1200 relating to a sixth embodiment of the present invention differs from the PDP 400 only in the shape of the multilayer electrode. In particular, the shape of the terminal part of the multilayer electrode in the sixth embodiment differs from the shape of the terminal part 108 in the PDP 400. Therefore, the explanation common to the PDP 400 is omitted here.

Hereafter, a component of the PDP 1200 corresponding to the multilayer electrode 409 is referred to as a multilayer electrode 1209, a part of the multilayer electrode 1209 corresponding to the terminal part 408 is referred to as a terminal part 1208, and a part of the multilayer electrode 1209 other than the terminal part 1208 is referred to as an electrode part 1210.

<Shape of the Multilayer Electrode>

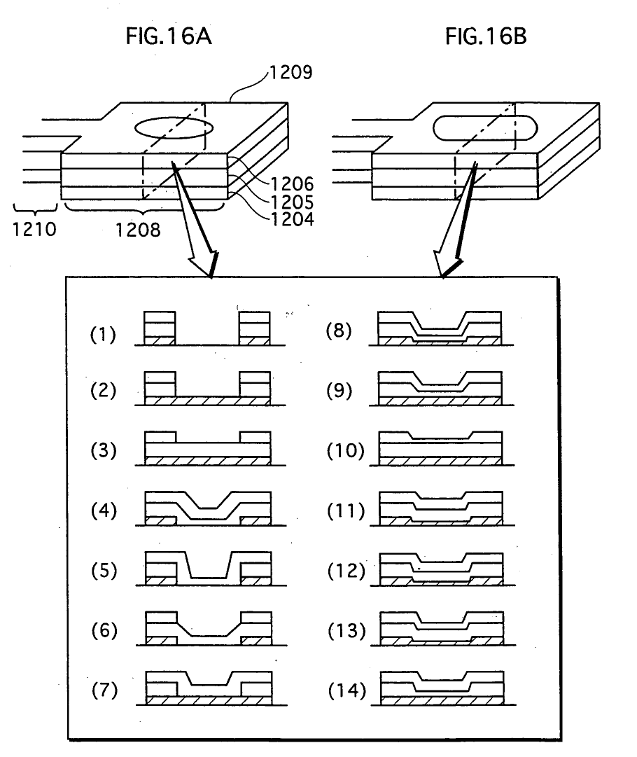

FIGS. 16A and 16B are diagrams for explaining the shape of the multilayer electrode 1209 of the PDP 1200 relating to the sixth embodiment.

For ease of explanation, a narrow part of the multilayer electrode 1209 extending to occupy a large area in the longitudinal direction is referred to as the electrode part 1210, and a wide and rectangular part of the multilayer electrode 1209 is referred to as the terminal part 1208.

As shown in FIGS. 16A and 16B, the terminal part 1208 has a recession or a through-hole on an extension of the electrode part 1210 in the longitudinal direction.

The shape of the recession or the through-hole may vary, such that it is circular as shown in FIG. 16A, or oval as shown in FIG. 16B.

<Construction of the Multilayer Electrode>

The multilayer electrode 1209 is composed of three layers, a lower layer, a middle layer, and an upper layer. The lower layer that comes in contact with the front glass substrate 401 is a black electrode film 1204 mainly composed of ruthenium oxide.

The middle layer provided on the black electrode film 1204 is a bus electrode 1205 mainly made from a conductive material containing Ag.

The upper layer provided on the bus electrode 1205 is another bus electrode 1206 mainly made from a conductive material containing Ag.

In short, the multilayer electrode 1209 has a triple-layer structure. The multilayer electrode 1209 has a triple-layer structure in its terminal part 1208 as well.

The terminal part 1208 with such a shape can be manufactured using the multilayer electrode manufacturing method relating to the first, second, third, fourth, and fifth embodiments, by interpreting the range of the thin part in these embodiments as a range where a recession or a through-hole is formed in the sixth embodiment.

To be more specific, a recession or a through-hole can be formed in the following ways. As one example, a range where a recession or a through-hole is to be formed may be excluded from a range where the photosensitive paste is printed. As another example, in a range where a recession or a through-hole is to be formed, the opening ratio of a screen used for printing may be reduced by changing the mesh number or subjecting the screen to calendering, so that an amount of printing can be reduced in that range. As still another method, in a range where a recession or a through-hole is to be formed, halftone exposure may be carried out to reduce a film thickness in that range.

In the case where a through-hole is to be formed in the terminal part 1208, all of the three layers of the terminal part 1208 are formed to have a thickness of 0 μm in a range where the through-hole is formed as shown in FIG. 16-(1). In the case where a recession is to be formed in the terminal part 1208, the three layers of the terminal part 1208 may be formed according to a plurality of variations of cross sections of the terminal part 1208 depending on which layer is formed to have a reduced thickness in a range where the recession is formed, and also depending on how much a thickness of the layer is reduced.

FIG. 16-(2) to FIG. 16-(14) show such variations of cross sections of the terminal part 1208.

FIG. 16-(2) shows a cross section of the terminal part 1208 when the three layers are formed in such a manner that the bus electrode 1205 and the bus electrode 1206 each have a thickness of 0 in a range where a recession is formed, and the black electrode film 1204 has a uniform thickness throughout the layer.

FIG. 16-(3) shows a cross section of the terminal part 1208 when the three layers are formed in such a manner that the bus electrode 1206 has a thickness of 0 in a range where a recession is formed, and the black electrode film 1204 and the bus electrode 1205 each have a uniform thickness throughout the layer.

FIG. 16-(4) shows a cross section of the terminal part 1208 when the three layers are formed in such a manner that the black electrode film 1204 has a thickness of 0 in a range where a recession is formed, and the bus electrode 1205 and the bus electrode 1206 each have a uniform thickness throughout the layer.

FIG. 16-(5) shows a cross section of the terminal part 1208 when the three layers are formed in such a manner that the black electrode film 1204 and the bus electrode 1205 each have a thickness of 0 in a range where a recession is formed, and the bus electrode 1206 has a uniform thickness throughout the layer.

FIG. 16-(6) shows a cross section of the terminal part 1208 when the three layers are formed in such a manner that the black electrode film 1204 and the bus electrode 1206 each have a thickness of 0 in a range where a recession is formed, and the bus electrode 1205 has a uniform thickness throughout the layer.

FIG. 16-(7) shows a cross section of the terminal part 1208 when the three layers are formed in such a manner that the black electrode film 1204 has a uniform thickness throughout the layer, the bus electrode 1205 has a thickness of 0 in a range where a recession is formed, and the bus electrode 1206 has a uniform thickness throughout the layer.

FIG. 16-(8) shows a cross section of the terminal part 1208 when the three layers are formed in such a manner that the black electrode film 1204, the bus electrode 1205, and the bus electrode 1206 each have a reduced thickness in a range where a recession is formed.

FIG. 16-(9) shows a cross section of the terminal part 1208 when the three layers are formed in such a manner that the black electrode film 1204 has a uniform thickness throughout the layer, the bus electrode 1205 and the bus electrode 1206 each have a reduced thickness in a range where a recession is formed.

FIG. 16-(10) shows a cross section of the terminal part 1208 when the three layers are formed in such a manner that the black electrode film 1204 and the bus electrode 1205 each have a uniform thickness throughout the layer, and the bus electrode 1206 has a reduced thickness in a range where a recession is formed.

FIG. 16-(11) shows a cross section of the terminal part 1208 when the three layers are formed in such a manner that the black electrode film 1204 has a reduced thickness in a range where a recession is formed, and the bus electrode 1205 and the bus electrode 1206 each have a uniform thickness throughout the layer.

FIG. 16-(12) shows a cross section of the terminal part 1208 when the three layers are formed in such a manner that the black electrode film 1204 and the bus electrode 1205 each have a reduced thickness in a range where a recession is formed, and the bus electrode 1206 has a uniform thickness throughout the layer.

FIG. 16-(13) shows a cross section of the terminal part 1208 when the three layers are formed in such a manner that the black electrode film 1204 and the bus electrode 1206 each have a reduced thickness in a range where a recession is formed, and the bus electrode 1205 has a uniform thickness throughout the layer.

FIG. 16-(14) shows a cross section of the terminal part 1208 when the three layers are formed in such a manner that the black electrode film 1204 and the bus electrode 1206 each have a uniform thickness throughout the layer, and the bus electrode 1205 has a reduced thickness in a range where a recession is formed.

The film thickness of the terminal part 1208 in a range where a recession is formed according to each of the above-described variations is, at its thinnest, 5 μm or less.

Also, in the case where a through-hole is formed in the terminal part 1208, the film thickness of the terminal part 1208 in a range where the through-hole is formed is 0.

Due to the presence of such a recession or a through-hole in the terminal part 1208, the terminal part 1208 has a cross section of a smaller area in a range where such a recession or a through-hole is formed than at other positions. Assume here that the terminal part 1208 is divided into three parts, namely, a joining part where a recession or a through-hole is formed, and an edge-side part and an opposite-side part that are joined by the joining part. The edge-side part is positioned at the edge side as viewed from the joining part in the longitudinal direction. The opposite-side part is positioned at the opposite side to the edge-side part as viewed from the joining part. This joining part has a cross section of a smaller area than the other parts. Therefore, the joining part produces the effect of hindering a force of pulling the edge-side part toward the opposite-side part. This can prevents generation of an excessive force of shrinkage in the edge-side part that is open-ended.

The presence of such a recession or a through-hole can therefore reduce shearing stresses in the X-axis direction generated, at the time of baking, in the edge-side part.

It should be noted here that if the vicinity of a periphery of a through-hole formed in the joining part is locally observed, shearing stresses in the X-axis direction substantially the same as those generated in conventional cases are generated in the opposite-side part in the vicinity of the periphery of the through-hole. However, if the distribution of shearing stresses in the X-axis direction is broadly observed, shearing stresses in the X-axis direction are small in the vicinity of the periphery of the through-hole because the opposite-side part where the through-hole is not provided has a contact surface with the front glass substrate extending in the X-axis direction. Therefore, in abroad range including the vicinity of the periphery of the through-hole in the Y-axis direction, such large shearing stresses in the Y-axis direction generated in conventional cases are not generated according to the present embodiment.

Due to this, the electrode peeling-off phenomenon is less likely to occur at the time of baking.

As described above, according to the PDP manufacturing method relating to the sixth embodiment, the multilayer electrode has, at its terminal part 1208, a recession or a through-hole where the minimum film thickness is 5 μm or less. The presence of a recession or a through-hole reduces shearing stresses generated in an edge-side part that is positioned at the edge side as viewed from the position of the recession or the through-hole. Therefore, the electrode peeling-off phenomenon can be prevented.

Although the sixth embodiment describes the case where a recession or a through-hole provided in the terminal part 1208 has a circular shape or an oval shape, the present invention should not be limited to such a shape of a recession or a through-hole.

Although the sixth embodiment describes the case where one recession or one through-hole is provided in the terminal part 1208, a plurality of recessions or a plurality of through-holes may be provided.

In the case where a plurality of recessions or through-holes are provided, it is preferable that one of the recessions or through-holes is positioned on an extension of the electrode part 1210 in the longitudinal direction, for the purpose of minimizing the force of pulling an edge-side part of the terminal part 1208 that is positioned at the edge-side as viewed from the recessions or the through-holes, toward an opposite-side part that is positioned at the opposite side to the edge-side part as viewed from the recessions or the through-holes.

### INDUSTRIAL APPLICATION

The present invention is applicable to manufacturing of gas discharge display panels such as PDPs for use as television or computer monitors etc.

1. A plasma display panel that includes a substrate on which a plurality of electrodes are arranged, the electrodes being formed by sintering a conductive material, characterized in that
each electrode includes (a), a first part that is positioned within a display area on the substrate, and (b) a second part that is positioned outside the display area on the substrate and that has a smaller film thickness than the first part.

2. The plasma display panel of claim 1, characterized in that
the display area is an area where cells corresponding to a discharge space are arranged.

3. The plasma display panel of claim 2, characterized in that
the film thickness of the second part is 5 μm or less.

4. The plasma display panel of claim 3, characterized in that
the second part occupies an area of the electrode from an end face of the electrode to a position that is at least 10 μm from the end face in a longitudinal direction.

5. The plasma display panel of claim 4, characterized in that
the first part includes at least a first electrode film and a second electrode film, and
an end of the first electrode film and an end of the second electrode film are at different positions, whereby the second part has a smaller thickness than the first part.

6. The plasma display panel of claim 5, characterized in that
the first electrode film is formed on the substrate, and the second electrode film is formed on the first electrode film, and
the end of the first electrode film is at a position that is away by a predetermined distance from the end of the second electrode film in such a manner that the end of the first electrode film extends from the end of the second electrode film.

7. The plasma display panel of claim 5, characterized in that
the first electrode film is formed on the substrate, and the second electrode film is formed on the first electrode film, and
the end of the second electrode film is at a position that is away by a predetermined distance from the end of the first electrode film in such a manner that the end of the second electrode film extends from the end of the first electrode film.

8. The plasma display panel of claim 7, characterized in that
the second electrode film contains at least one member selected from the group consisting of Ag, Cu, and Al.

9. The plasma display panel of claim 8, characterized in that
the first electrode film contains at least one member selected from the group consisting of Ag, Cu, Al, a black pigment, ruthenium oxide, and a complex compound of ruthenium, and
the first electrode film shows one of black and gray.

10. A plasma display panel that includes a substrate on which a plurality of electrodes arranged, the electrodes being formed by sintering a conductive material, characterized in that
each electrode has an end part with a larger width than other parts of the electrode, and
at least one recession or through-hole is formed in the end part.

11. The plasma display panel of claim 10, characterized in that
at least one recession or through-hole is positioned on an extension of a longitudinal direction of a main part of the electrode other than the end part.

12. (Cancelled)

13. A manufacturing method for a plasma display panel that includes a substrate, characterized by comprising:
an applying step of applying, on the substrate, a conductive material in a plurality of lines each extending over both a display area and an area outside the display area; and
a baking step of baking the conductive material, to form electrodes,
wherein each electrode formed by baking includes (a) a first part that is positioned within the display area on the substrate, and (b) a second part that is positioned within the area outside the display area on the substrate and that has a smaller film thickness than the first part.

14. The manufacturing method of claim 13, characterized in that
the display area is an area where cells corresponding to a discharge space are arranged.

15. The manufacturing method of claim 14, characterized in that
the film thickness of the second part is 5 μm or less.

16. The manufacturing method of claim 15, characterized in that
in the applying step, the conductive material is applied in such a manner that the second part of the electrode formed by baking occupies an area of the electrode from an end face of the electrode to a position that is at least 10 μm from the end face in a longitudinal direction.

17. The manufacturing method of claim 13, characterized in that
in the applying step, the conductive material is applied as at least two layers that are a first layer and a second layer in a first area where the first part of the electrode is to be formed, and the conductive material is applied as one of the first layer and the second layer in a second area where the second part of the electrode is to be formed.

18. The manufacturing method of claim 17, characterized in that
in the applying step, the conductive material is applied by printing, and
the conductive material is applied by printing one of the first layer and the second layer in the second area.

19. The manufacturing method of claim 13, characterized in that
in the applying step, the conductive material is applied as at least two layers that are a first layer and a second layer, and
the conductive material is applied by printing the first layer and the second layer in such a manner that a smaller amount of the conductive material is applied as the first layer or the second layer in a second area where the second part of the electrode is to be formed, than in a first area where the first part of the electrode is to be formed.

20. The manufacturing method of claim 19, characterized in that
a first mesh is used in applying the conductive material in the first area, and a second mesh with a smaller opening ratio than the first mesh is used in applying the conductive material in the second area, so that a smaller amount of the conductive material is applied in the second area than in the first area.

21. The manufacturing method of claim 19, characterized in that
a first mesh is used in applying the conductive material in the first area, and a mesh that is obtained by subjecting the first mesh to calendering is used in applying the conductive material in the second area, so that a smaller amount of the conductive material is applied in the second area than in the first area.

22. The manufacturing method of claim 13, characterized in that
the conductive material is mixture with a photosensitive material,
in the applying step, the mixture is applied as at least two layers on the substrate (a) by printing the mixture or (b) by applying laminated sheets of the mixture, and
in a second area where the second part of the electrode is to be formed, exposure is carried out using an exposure mask with such a tone width that does not exceed exposure resolution and then developing is carried out, to form the two layers.

23. A manufacturing method for a plasma display panel that includes a substrate, characterized by comprising:
an applying step of applying, on the substrate, a conductive material in a plurality of lines each extending over both a display area and an area outside the display area on the substrate, each line of the conductive material having an end part with a larger width than other parts of the line and having at least one recession or through-hole in the end part; and
a baking step of baking the conductive material, to form electrodes.

24. The manufacturing method of claim 23, characterized in that
at least one recession or through-hole is positioned on an extension of a longitudinal direction of a main part of the line other than the end part.

25. A plasma display panel of claim 1, characterized further by a driving circuit operatively connected to the plurality of electrodes.

26. A plasma display panel of claim 10, characterized further by a driving circuit operatively connected to the plurality of electrodes.
